(19) United States
(12) Patent Application Publication
(10) Pub. No.: US 2001/0020255 A1
(43) Pub. Date: Sep. 6, 2001

(54) Method and system for remote control and interaction with a run time environment component

(75) Inventors: Ralf Hofmann, Hamburg (DE); Torsten Schulz, Pinneberg (DE)

Correspondence Address: Forrest Gunnison, Gunnison, McKay & Hodgson, L.L.P, 1900 Garden Road, Suite 220, Monterey, CA, 93940, US

(73) Assignee: Sun Microsystems, Inc.

(21) Appl. No.: 09/759,786

(22) Filed: Jan. 12, 2001

(30) Foreign Application Priority Data
Jan. 14, 2000 (EP) 00100739.2

(51) Int. Cl. G06F 15/16; G06F 9/54

(52) U.S. Cl. 709/318; 709/313; 709/201

(57) ABSTRACT

A user device, a first computer system, includes a lightweight component that receives user input actions for a runtime environment component that is executing on a second computer system. The lightweight component sends a remote input action command to a user interface infrastructure that is executing on the second computer system. In response to the remote input action command, the user interface infrastructure sends a local input action command to the runtime environment component that processes the command, and issues a local output command to the user interface infrastructure that in turn sends a remote output command to the lightweight component on the user device. In response to the remote output command, the lightweight component causes an output on the user device.

### BACKGROUND OF THE INVENTION

1. Field of the Invention

The present invention relates to runtime environment component services, and in particular to a runtime environment component services provided by a first computer system to a second computer system over a communication network.

2. Description of Related Art

Today, many computer networks are arranged as client-server systems. In a client-server system, a potentially large number of smaller computer systems, like laptops or handhold organizers, called clients, are, temporarily or permanently connected to a larger computer system, called server. The connection between the clients and the server may be effected, for example, via the Internet.

In client-server systems, a client typically has limited storage and processing capabilities. Nevertheless, many software programs are executed on the clients. One prior art way to make a software program on the server available to clients was to use a browser on the client. The browser was used to transfer a relatively large software program or a relatively large part thereof from the server to a client so that the software program could be executed locally on the client. This method required that the software program or a part thereof be stored and processed on the client.

For this purpose, the client must have sufficient storage capacity and processing capability to execute the software program locally. These requirements may conflict with the aim of having smaller and smaller clients, including cellular telephones, which may not have enough storage capacity or processing capability for storing or processing, respectively, large software programs or large parts of software programs.

Frequently, a software program requested by a client for execution is transferred every time the software program is executed. The speed of this download depends on the available data transfer capacity of the network connecting the server and the client. Here, frequently the available bandwidth of the network connection is decisive. In many instances the described client-server systems would be undesirably slow in executing a software program, because the download takes too much time.

Therefore, software programs, which are called frequently for execution on a client, may be permanently, or at least for some time, stored on the client. This leads, however, to the task of regularly, and maybe even individually, updating a potentially large number of clients, if relevant software programs are amended or updated. Considerable administration efforts for client-server systems may be the consequence.

It is also known to include into a software program executed on a client procedures, which are executed on a server. A prior technique to implement this used CORBA. For example, certain more complicated calculations, the result of which may be needed on a client, were carried out on a server connected with the client over a network. However, this required that the program developer include particular commands into the code of the software program to be executed on the client for calling the software program to be executed on the server, in the given example the calculation program. This was not only cumbersome, but also led to incompatibilities when the software program to be executed on the server was amended.

It is further known to allow a user to initiate execution of a program server from a client and to review the results of the program execution on the client. This approach is used in the UNIX X-Windows system. However, this approach did not permit the client to control the program and did not permit integration of server side functionality into the client side environment at the level of function calls.

### SUMMARY OF THE INVENTION

According to one embodiment of the present invention, a user device, a first computer system, includes a lightweight component that receives user input actions for a runtime environment component that is executing on a second computer system. The lightweight component sends a remote input action command to a user interface infrastructure that is executing on the second computer system.

In response to the remote input action command, the user interface infrastructure sends a local input action command to the runtime environment component that processes the command, and issues a local output command to the user interface infrastructure that in turn sends a remote output command to the lightweight component on the user device. In response to the remote output command, the lightweight component causes an output on the user device. This output could be redrawing a display, playing a sound, or perhaps routing information to a local printer.

All the management of components in the user interface, management of data and so on is performed on the second computer system and so the lightweight component only has, for example, to update the display to reflect the state of the runtime environment component as indicated by the remote output command received. It appears to the user that the runtime environment component is executing locally on the user device despite that fact that the user device is only functioning as an input/output device for the runtime environment component.

In one embodiment, a method for presenting a runtime environment component service by a first computer system to a second computer system over a communication network is performed by the first computer system. The method includes generating a user interface infrastructure on the first computer system. The user interface infrastructure receives graphic user interface events from the second computer system and sends remote graphic user interface commands to the second computer system. The user interface infrastructure is used to initialize the runtime environment component service. The runtime environment component service sends graphic user interface commands to the user interface infrastructure.

In another embodiment, the first computer system receives a remote input action command for a runtime environment component service via a communication network. The remote input action is being generated in the second computer system by a lightweight component corresponding to the runtime environment component service. A local input action command is transmitted to the runtime environment component service in response to the remote input action command. The local input action command is processed by the runtime environment component service, and a local output command is generated by the runtime environment component service for a graphical user interface. A remote output command is transmitted to the lightweight component in response to the local output command.

In yet another embodiment, a method for enabling a user device to run a runtime environment component on another computer includes running a browser on the user device. A lightweight component is run within the browser. The lightweight component receives user input actions on the user device and generates corresponding user interface events to the another computer for processing by the runtime environment component.

A computer program product, in one embodiment, comprises computer code including a remote frame window class that in turn includes a remote output device interface and a remote frame window interface. The computer code optionally includes any or all of a bean frame class comprising a frame interface; a bean window class including an event handler interface and a window peer interface; and an abstract windowing toolkit.

### BRIEF DESCRIPTION OF THE DRAWINGS

FIG. 1 is an illustration of one embodiment of the present invention with a plurality of user devices that each can execute a lightweight component that corresponds to at least one component on the server computer system.

FIG. 2 is a more detailed illustration of one embodiment of the present invention with a representative user device that executes a lightweight component that corresponds to at least one component on the server computer system.

FIG. 3 is a process flow diagram for one embodiment of the present invention.

FIG. 4 is an architecture diagram for one embodiment of the present invention.

FIGS. 5A to 5D are a sequence diagram for a JAVA-based implementation of one embodiment of the present invention.

FIG. 6 is a class diagram for the embodiment of the present invention illustrated in FIGS. 5A to 5D.

FIG. 7 is a cross-reference between Tables in the description and selected interfaces in FIG. 6.

FIGS. 8A to 8C are a cross-reference between Tables in the description and selected interfaces in FIG. 6.

FIG. 9 is a cross-reference between Tables in the description and selected interfaces in FIG. 6.

FIGS. 10A and 10B are a cross-reference between Tables in the description and selected interfaces in FIG. 6.

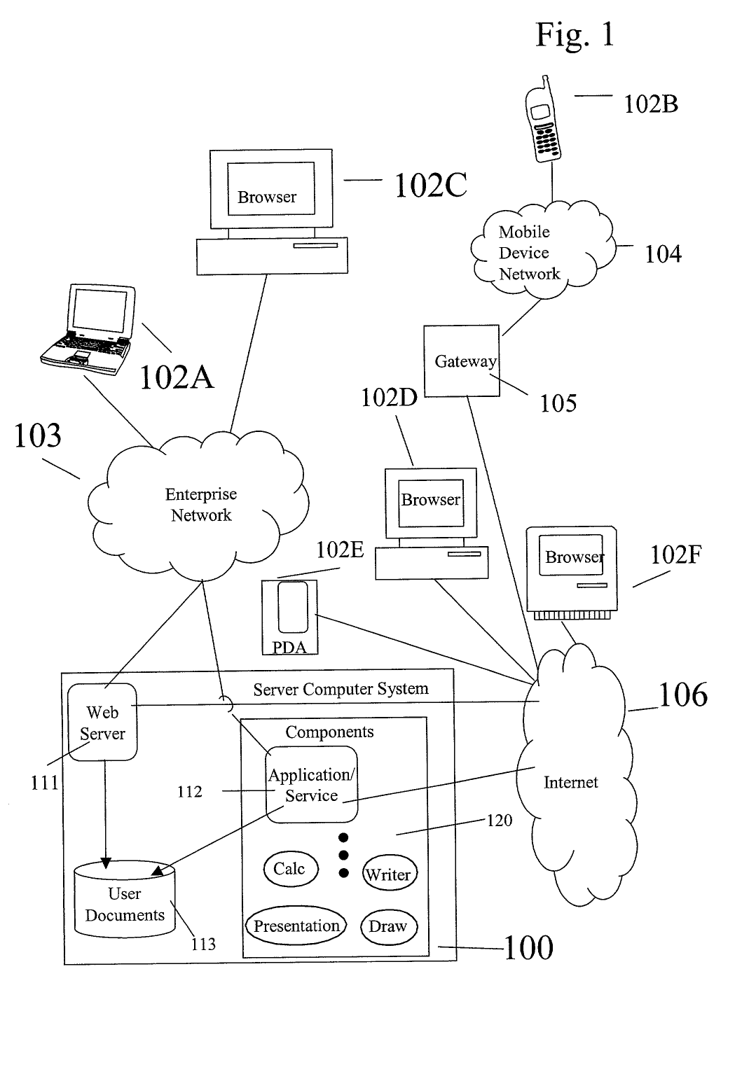

In the drawings and the following detailed description, elements with the same reference numeral are the same element. Also, the first digit of a reference numeral for an element indicates the first drawing in which that element appeared. A word in italics and the same word not in italics represent the same element. The italics are used only for convenience and not to denote different embodiments or elements.

### DETAILED DESCRIPTION

According to one embodiment of the present invention, a user can access and use applications or services, e.g., application 112 in a suite of applications 120, on server computer system 100 from almost any available device, e.g., any one of a portable computer 102A, a mobile telephone 102B, a workstation 102C, a home personal computer (PC) 102D, a personal digital assistant 102E, or an Internet café machine 102F. No longer is a user limited to using either workstations and/or portable computers with suite of applications 120 installed thereon.

For example, a user on a vacation overseas suddenly realizes that the presentation her boss is going to deliver the next morning contains a critical error. The user drops by an Internet café and from any machine 102F at the café accesses the presentation via server computer system 100, and makes the necessary corrections using applications written, for example, in a visual basic programming language and/or the C++ programming language even though only a browser is available on machine 102F.

In another scenario, the user is having dinner at a friend's house, and gets an urgent call saying that a report that can be assessed via server computer system 100 must be revised that evening. The revisions will not require much work, but the trip to the office and back is a very unwelcome prospect. Using the friend's PC 102D and the friend's Internet service provider, the user works on the report without leaving his friend's home even though no software for accessing application suite 120 is available on PC 102D. The user interface on PC 102D and the application capability is that same as if the user were executing the application at the office.

Another user is expecting an important document, but the user has a business appointment outside the office. The document arrives by e-mail while the user is in transit. Using a PDA 102E while on the train, the user accesses the e-mail using server computer 100, reviews the document, and then re-directs the document to the fax machine at the site to which the user is going.

A customer would like to meet with a user tomorrow. The user thinks he will be available, but the user doesn't know whether anyone scheduled the time while the user was away from the office, and now the office is closed. Using a mobile telephone 102B, the user accesses his up-to-the-minute calendar via server computer system 100 and schedules the appointment.

Hence, in one embodiment, using a web browser and an Internet connection, the user simply logs on to a web server 111, and proceeds as though everything were locally resident on his/her machine. While execution actually takes place on server computer system 100, this fact is transparent to the user. Similarly, local services available on a client system, including devices like printers and local storage, can be utilized in a transparent manner.

In addition to using browsers, users can access applications on server computer system 100, sometimes called server 100, from Wireless Application Protocol (WAP) devices, which include mobile phone 102B and perhaps PDA 102E. Because of the limited capabilities of devices 102B and 102E, functionality is not as extensive as from a system that can run a full browser. Accordingly, in one embodiment, users are able to view their mail and data, but users don't have full editing capabilities in this embodiment. However, users can use mobile phones and PDAs to manage their data and the users can direct the movement of information to other devices.

Hence, a user of any one user device 102i, where i is A to G, of a plurality of devices 102A to 102G can use an application 112, or any other application in suite 120 that can include for example a word processing application, a spreadsheet application, a database application, a graphics and drawing application, an e-mail application, a contacts manager application, a schedule application, and a presentation application, as if that application were executing locally on user device 102i. One office application package suitable for use with this invention, is the STAROFFICE Application Suite available from Sun Microsystems, 901 San Antonio Road, Palo Alto, Calif. (STAROFFICE is a trademark of Sun Microsystems, Inc.) The user has access to the functionality of application 112 even in situations where user device 102i has neither the memory capacity nor the processing power to execute application 112.

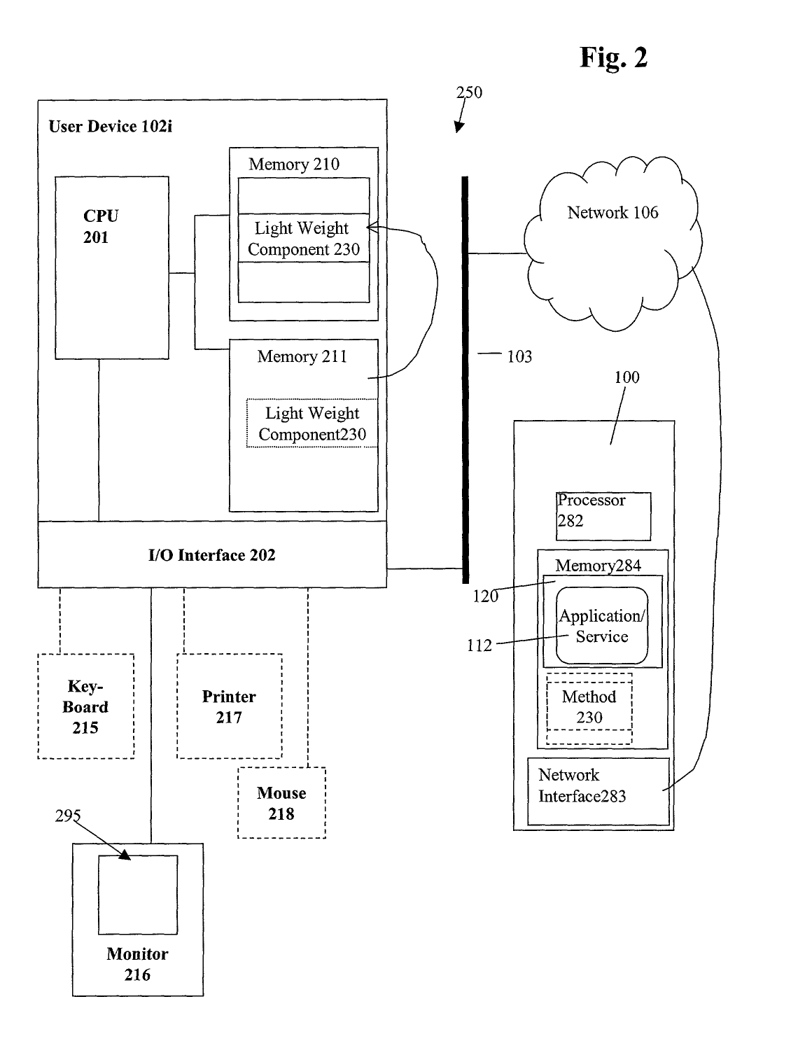

As explained more completely below, in each of the above examples, a lightweight component 230 (FIG. 2) is either stored locally in a memory of user device 102i, or is downloaded from server computer system 100 (FIG. 2) to memory 211 in user device 102i. Lightweight component 230, in the embodiment, is loaded in a browser, to communicate over a network, e.g., enterprise network 103, Internet 106, or a combination of the two 103/106, with application 112 that is executing on server computer system 100.

Lightweight component 230, as explained more completely below, is not a prior art software program. Rather lightweight component 230, in one embodiment, maps visual display instructions from application 112 executing on server computer system 100 to a platform dependent graphic layer that in turn generates a user interface on display screen 295 of monitor 216. The user interface for application 112 is similar to the user interface that the user would see if application 112 were executing locally on device 102i. The interfaces may not be identical if user device 102i has limited input/output capability, e.g., user device 102i is a mobile telephone.

When lightweight component 230 receives an input event from the windowing environment executing on user device, e.g., the JAVA Abstract Windowing Toolkit (AWT), lightweight component 230 transmits the event to application 112 for processing. Here, the input event could be selection of a menu item, configuration of a menu, a keyboard input, a mouse input, or any other input event supported by application 112.

Application 112, executing on server computer system 100 processes the event received from lightweight component 230 and performs any operations required on server computer system 100. Output instructions from application 112 are directed to lightweight component 230 on user device 102i.

When lightweight component 230 receives the output instructions, lightweight component 230 executes the instructions. For example, if the instructions are to update the display, lightweight component 230 maps the instruction to a platform dependent graphic layer that in turn redraws the display. All the management of components in the user interface, management of data and so on is performed on server computer system 100 and so lightweight component 230 only has to update the display to reflect the state of application 112 as indicated by the output instructions received from application 112.

Consequently, it appears to the user that application 112 is executing locally on user device 102i despite that fact that user device 102i is only functioning as an input/output device for application 112. Lightweight component 230 on user device 102i routes the output to an output device of device 102i, e.g., a display unit 216 or a locally connected printer 217.

As used herein a lightweight component 230, sometimes called a thin client, is software, which, upon execution, is able to provide input to and receive output from a runtime environment component, e.g., an application or service 112 that is sometime called a runtime environment component 112. Lightweight component 230 is tiny enough to be downloaded from first computer system 100 onto second computer system 102i via a network 103 and 106 within a time significantly smaller than the time required to download the whole runtime environment component 112.

In one embodiment, the download time t is particularly, but not necessarily, defined as

t<(8 N/C_{B})+t₁,

where N is the size of runtime environment component 112 in bytes, C_{B} is the average bandwidth in bits per second of the network connection between first computer system 100 and second computer system 102i, and t₁ is the time needed to initialize runtime environment component 112 in its respective local environment on first computer system 100. In today's commonly available network connections between servers and clients, time t is typically be about ten seconds.

When using networks commonly used at present for the connection of clients and servers, this time condition gives a lightweight component 230, which is-measured in necessary storage space-less than ten or even less than five percent of the scope of the totality of the runtime environment components 120, which can be requested by lightweight component 230, including any auxiliary software programs which these runtime environment components need to be executed in first computer system 100.

Correspondence of lightweight component 230 with runtime environment component 112 means, in this context, that lightweight component 230 must offer the second computer system 102i access to the runtime environment component service made available by component 112. If a plurality of runtime environment component services 120 is made available by the lightweight component 230, which will frequently be the case, lightweight component 230, in this embodiment, corresponds to this plurality of runtime environment component services in the explained sense.

Hence, in this embodiment, the software system includes two parts, a first part 230 executed on a client device 102i, and a second part 120 residing and executed on server computer system 100. Second part 120 on server 100 makes up the runtime environment, which, in this embodiment, comprises a plurality of runtime environment components, which are able to provide services. Furthermore, second part 120 on server computer system 100 provides the necessary communication tools in order to communicate with client device 102i, sometimes called user device 102i.

The other part 230, being executed on client device 102i, performs communication between client device 102i in requesting a runtime environment component service being executed on server 100. The server's part of the software system is by far larger in size than the client's part thereof. This latter part is referred to as lightweight component 230. A typical size of the software system's part 120 on server computer system 100 may be 50 to 100 Megabyte, e.g., an office software package, whereas lightweight component 230 on client device 102i has a typical size of 400 Kilobyte, and uses minimal system resources (CPU power, memory).

Lightweight component 230 provides an application-programming interface (API) for any application program the implementation of which on client device 102i is allowed by an implementation framework on server computer system 100. Various types of lightweight components 230 are possible. In one embodiment, the lightweight component accesses a particular functionality, e.g., a mathematical calculator on server 100, which provides a specific result to user device 102i for use. In another embodiment, lightweight component 230 handles visual functionality.

Hence, in more general terms, runtime environment component services are presented by a first computer system 100 to a second computer system 102i over a communication network 103/106. Upon receiving a request for a runtime environment component service transmitted by second computer system 102i over communication network 103/106, first computer system 100 executes a runtime environment component 112 for producing a result according to the received request, and transmits, over network 103/106, a response comprising the result to the second computer system 102i.

Herein, computer software programs and parts thereof, which are called during execution of a lightweight component 230, are herein referred to as runtime environment components 120. The functionality provided by runtime environment components 120 to lightweight component 230 are herein referred to as runtime environment component services. The size of runtime environment components 120 renders a distribution over Internet 106 difficult. Runtime environment components 120 may be implemented in any suitable form. Runtime environment components 120 may consist of compiled software program code to be executed or of script code in any programming language to be interpreted before execution by a compiler. Runtime environment components 120 are typically stored and administrated on server computer system 100.

Lightweight component 230 makes runtime environment component services, that means the functionalities provided by runtime environment components 120, available for use without integrating components 120 into lightweight component 230 and without distributing components 120 together with lightweight component 230 to the place of execution of lightweight component 230, for example, client device 102i.

Further, the full functionality of the runtime environment components 120 is available for all kinds of client devices independent of whether the client devices are powerful enough to store or to execute a runtime environment component 112. Further, the user of a client device is not charged with the problem of whether a specific runtime environment component 112 is available on client device 102i.

The holding, maintaining and administrating runtime environment components 120, as well as executing runtime environment components 120, is placed on first computer system 100. Nevertheless, second computer system 102i can profit from these runtime environment component services as if the corresponding runtime environment components 120 were present locally on second computer system 102i. Therefore, additional functionality is provided even to those computer systems, which are not powerful enough to store and/or execute the full range of runtime environment components 120, as for example notebooks, handheld computers, organizers and mobile telephones.

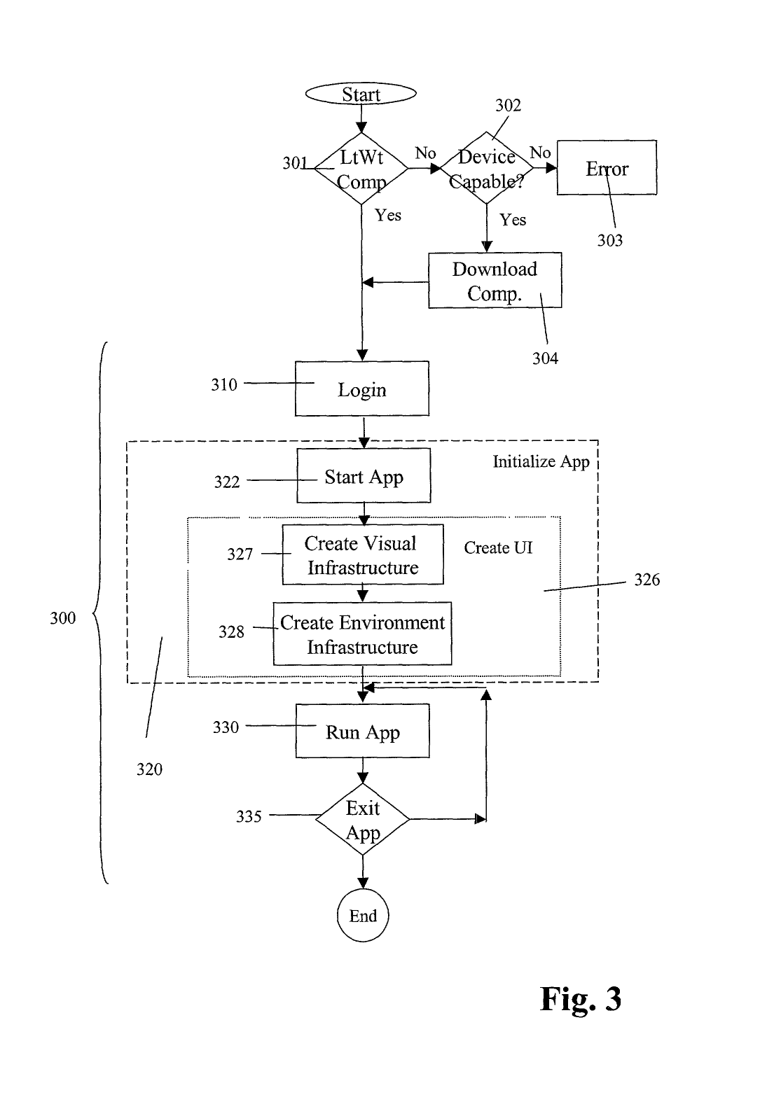

FIG. 3 is a process flow diagram for one embodiment of method 300 of this invention. Initially, a user of device 102i issues a request to use applications 120 over network 103/106 to web server 111. The transmission of the request over the network 103/106 is performed according to a predetermined transmission protocol. In response to the request from user device 102i, web server 112 determines in lightweight component available check operation 301 whether the request was from lightweight component 230. If the request was from lightweight component 230, processing transfers to login operation 310 and otherwise to device capability check operation 302

Device capability check operation 302 determines whether user device 102i can execute and use lightweight component 230, e.g., is there a lightweight component 230 available for the general type of user device 102i, and is the operating system, processor, and memory of specific user device 102i sufficient to execute and support lightweight component 230. This information may be included in the initial request, a process on server computer system 100 may communicate with user device 102i to obtain the information, or alternatively, the request may include an identifier that is used to access a database to determine the capabilities of user device 102i.

If user device 102i is capable of executing and supporting lightweight component 230, processing transfers to download component operation 304 and otherwise to return error operation 303. Return error operation 303 sends an appropriate error message to user device 102i to inform the user of the incompatibility between requested application 112 and user device 102i.

Download component operation 304 downloads, and installs if necessary, lightweight component 230 on user device 102i. Thus, prior to starting login operation 310, lightweight component 230 is available on user device 102i.

In response to the request to access applications 120, in login operation 310, a connection is established over network 103/106 to a daemon executing on server 112. The daemon returns a handle to a daemon service factory to lightweight component 230.

Upon receipt of the handle to the daemon service factory, lightweight component 230 issues a request to the service factory to initiate execution of a login service on server computer system 100. Upon activation of the login service, lightweight component 230 transmits a user identification, a password, and options for runtime environment components 120 to the login service. The login service on server 100 validates the user login in login operation 310 and transfers to initialize application operation 320.

Start application operation 322 within operation 320 activates a service factory for runtime environment components 120 on server 100 and returns a handle to this service factory to lightweight component 230. Operation 322 transfers processing to create user interface operation 326 within initialize application operation 320.

In create user interface operation 326, lightweight component 230 issues a request to the runtime environment components service factory to start an infrastructure generation service. In response to the request, the service factory, executing on server computer system 100, activates the infrastructure generation service, and returns a handle to this service to lightweight component 230. Processing transfers to create visual infrastructure operation 327.

In operation 327, lightweight component 230 issues a request to start the infrastructure generation service, and passes a handle to a client factory to the service. Lightweight component 230 next issues a request to create a visual infrastructure on server computer system 100 for processing the visual portion of the user interface.

In response to the request from lightweight component, 230, the infrastructure generation service first issues a request to the client factory on user device 102i to create a remote frame window, and then this service creates a corresponding server window object on server computer system 100. The server window object queries the remote frame window on user device 102i to determine the fonts, display parameters, etc. on user device 102i. Alternatively, the server window object can obtain identifier information from user device 102i and then use this identifier information to access a database that includes the display capabilities of device 102i. Upon completion of the queries, operation 327 transfers to create environment infrastructure operation 328.

In operation 328, the infrastructure generation service creates a frame object that controls the environment of the server window object and creates a direct connection between the frame object and lightweight component 230. Operation 328 transfers to run application operation 330.

In run application operation 330, lightweight component 230 sends a command to the frame object to load a particular document in application 112. In response, the frame object initializes application 112 and loads the document in application 112.

Application 112 reads the loaded document, and generates a display layout that is sent to the server window object. In turn, the server window object sends the display layout to the remote frame window in lightweight component 230. The remote frame window generates commands to a device dependent graphic layer, e.g., the JAVA AWT, which in turn generates the user interface on display screen 295 of monitor 216, in this embodiment.

If user device 102i has limited input/output capability, the user may be able to only read the document, or perhaps direct the document to a local output device if application 112 includes such a capability, e.g., a capability to write to a local printer or to write to a fax printer. If as in FIG. 2, user device 102i includes multiple input/output devices, the user can utilize the full functionality of application 102i. For example, if the user utilizes mouse 218 to scroll down in the document. The scroll action is interpreted by the windowing environment on user device 102i and a scroll command is set by the windowing environment to the remote window frame of lightweight component 230.

The remote window frame, in turn, sends a scroll command over network 103/106 to the server window object on server 100. The server window object processes the event received and generates an application event that in turn is processed by application 112. In this example, application does a re-layout based on the scrolling, and redraws the display in the server window object that in turn sends a redraw command to the remote frame window on user device 102i.

In one embodiment, the transmissions over network 103/106 between lightweight component 230 and server 100 are encrypted according to known technologies. Further, in another embodiment, digital signatures are used to provide certification of the request mechanism being established on the client for this runtime environment component services system.

The size of a lightweight component 230 does not increase with the number of accessed runtime environment components of the implementation server framework. This introduces the ability to offer runtime environment components, which expose only services designed for a special purpose and hide the complexity of the implementation framework.

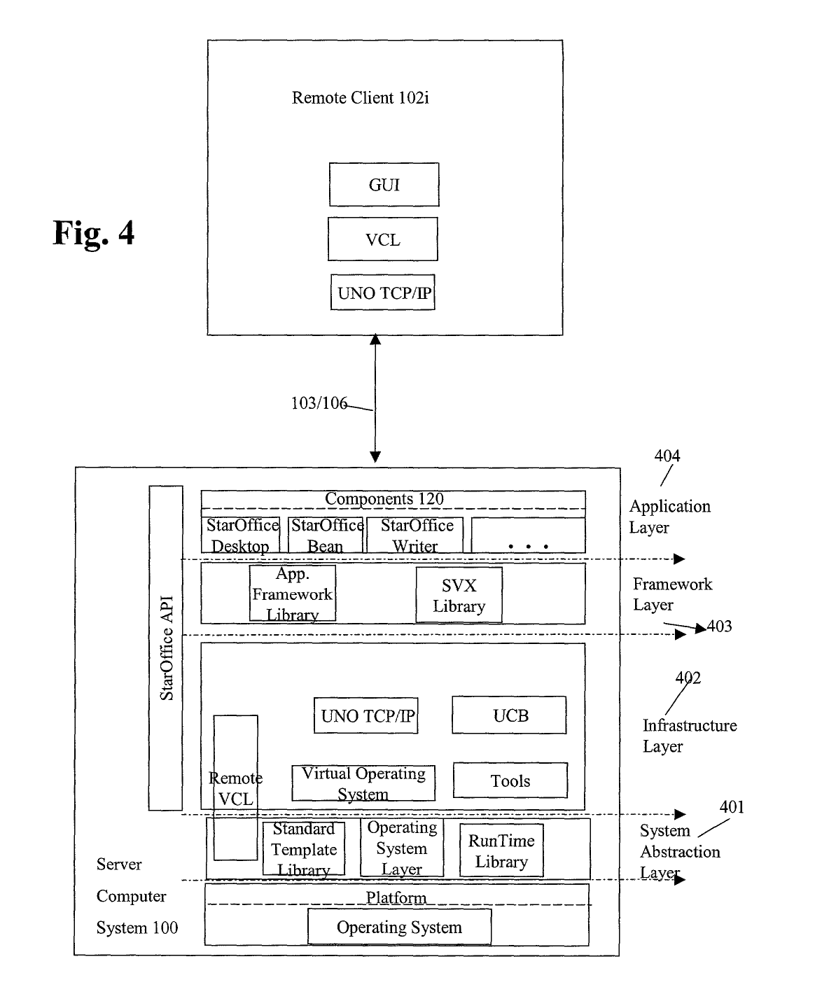

In one embodiment of the invention, the STAROFFICE application suite is utilized as runtime environment components 120 on server computer system. FIG. 4 is an illustration of a layer architecture of the STAROFFICE application suite used in this embodiment.

System abstraction layer 401 encapsulates all system specific APIs and provides a consistent object-oriented API to access system resources in a platform independent manner. All platform dependent implementation is below this layer, or is part of optional modules. To reduce the porting effort, the functionality provided by system abstraction layer 401 is reduced to a minima set available on every platform. Also, for some systems, layer 401 includes some implementations to emulate some functionality or behavior. For example on systems where no native multi threading is supported, layer 401 can support so called “user land” threads.

The operating system layer (OSL) within layer 401 encapsulates all the operating system specific functionality for using and accessing system specific resources like files, memory, sockets, pipes, etc. The OSL is a very thin layer with an object oriented API.

The runtime library within layer 401 provides all semi platform independent functionality. There is an implementation for string classes provided. Routines for conversion of strings to different character sets are implemented. The memory management functionality resides in this module.

As a generic container library with layer 401, the standard template library is used. This library supplies implementations for list, queues, stacks, maps, etc.

The remote visual class library (VCL) is shown as bridging infrastructure layer 402 and system abstraction layer 402. Remote VCL receives all user interface events and sends responses to user interface events over network to lightweight component 230 on another computer, which then displays the actual output as described above. Remote VCL encapsulates all access to the different underlying GUI systems on different client devices. Remote VCL is a high level definition of a graphic device defined as a set of interfaces. Remote VCL is based completely on a component infrastructure. This gives remote VCL the ability to map functionality, which a client system is unable to support, to a service component on the server side emulating this functionality.

The implementation of remote VCL is platform independent and includes an object oriented 2D graphics API with metafiles, fonts, raster operations and the whole widget set use by the STAROFFICE application suite. This approach virtually guarantees that all widgets have the same behavior independently of the used GUI system on the different platforms. Also the look & feel and the functionality of the widgets are on all platforms the same. Remote VCL includes a mapping to the interface of the lightweight component that is described more completely below. Since this mapping is platform independent, remote VCL does not access any native window system.

Infrastructure layer 402 is a platform independent environment for building application, components and services. Layer 402 covers many aspects of an object oriented API for a complete object oriented platform including a component model, scripting, compound documents, etc.

To make the usage of system resources like files, threads, sockets, etc. more convenient the virtual operating system layer encapsulates all the functionality of the operating system layer into C++ classes. The tools libraries are different small libraries building up a set of tool functionality. This includes a common implementation for handling date and time related data. There is an implementation for structured storages available. Other implementations provide a generic registry, typesafe management and persistence of property data.

Universal network objects are a component technology that does not depend on any graphical subsystem, but are heavily based on multithreading and network communication capabilities. The system consists of several pieces. An IDL-Compiler, which generates out of the specified definition of an interface a binary representation and the associated C-Header or JAVA technology files. The binary representation is platform and language independent and is at runtime used to marshal arguments for remote function calls or to generate code on the fly for a specific language to access the implementation provided by the interface. Many parts of the UNO technology are implemented as UNO components. This helps to create a very flexible system and also the extension of the system at runtime. For example, by providing new bridges or communication protocols, UNO provides transparent access to components over the network or locally. For a more complete description of bridges, see copending, cofiled, and commonly assigned U.S. patent application Ser. No. 09/xxx,xxx, entitled “A METHOD AND SYSTEM FOR DYNAMICALLY DISPATCHING FUNCTION CALLS FROM A FIRST EXECUTION ENVIRONMENT TO A SECOND EXECUTION ENVIRONMENT,” of Markus Meyer (Attorney Docket No. 4355), which is incorporated herein by reference in its entirety. For the communication over the network, IIOP can be used. If the components are realized as shared libraries, the components can be loaded into to the process memory of the application and every access of the component is just like a function call without any marshalling of arguments which is required for remote function calls.

The Universal Content Broker (UCB) allows all upper layers to access different kind of structure content transparently. The UCB includes a core and several Universal Content Providers, which are used to integrate different access protocols. One implementation provides content providers for the HTTP protocol, FTP protocol, WebDAV protocol and access to the local file system.

The UCB not only provides access to the content, but also the UCB provides the associated meta information to the content. Actually, synchronous and asynchronous modes for operations are supported. A more complete description of the UCB is provided in copending, cofiled, and commonly assigned U.S. patent application Ser. No. 09/xxx,xxx, entitled “A NETWORK PORTAL SYSTEM AND METHODS” of Matthias Hütsch, Ralf Hofmann and Kai Sommerfeld (Attorney Docket No. 4595), which is incorporated herein by reference in its entirety.

Framework layer 403 allows the reuse of implementations in different applications. Layer 403 provides the framework or environment for each application and all shared functionality like common dialogs, file access or the configuration management

The application framework library in layer 403 provides an environment for all applications. All functionality shared by all applications and not provided by any other layer is realized here. For the framework every visual application has to provide a shell and can provide several views. The library provides all basic functionality so only the application specific features have to be added.

The application framework library is also responsible for content detection and aggregation. The template management is provided here and the configuration management too. The application framework library is in some areas related to the compound documents, because of the functionality for merging or switching menu-and toolbars. Also, the library provides the capability for customization of all applications.

The SVX library in layer 403 provides shared functionality for all applications, which is not related to a framework. So part of the library is a complete object oriented drawing layer, which is used by several applications for graphic editing and output. Also a complete 3D-rendering system is part of the drawing functionality. The common dialogs for font selection, color chooser, etc. are all part of this library. Also the whole database connectivity is realized here.

All applications are part of application layer 404. The way these applications interact is based on the lower layers. All applications like the word processor application, spreadsheet application, presentation application, charting application, etc. build up this layer. All these applications are realized as shared libraries, which are loaded by the application framework at runtime. The framework provides the environment for all these applications and also provides the functionality for how these applications can interact.

In one embodiment, the user interface library is implemented using native compiled computer code using the visual class library (VCL) that encapsulates all access to the GUI system on user device 230 by application 112 that is executing on server computer system 100. In another embodiment, the user interface library that includes the VCL functionality is implemented in the JAVA programming language.

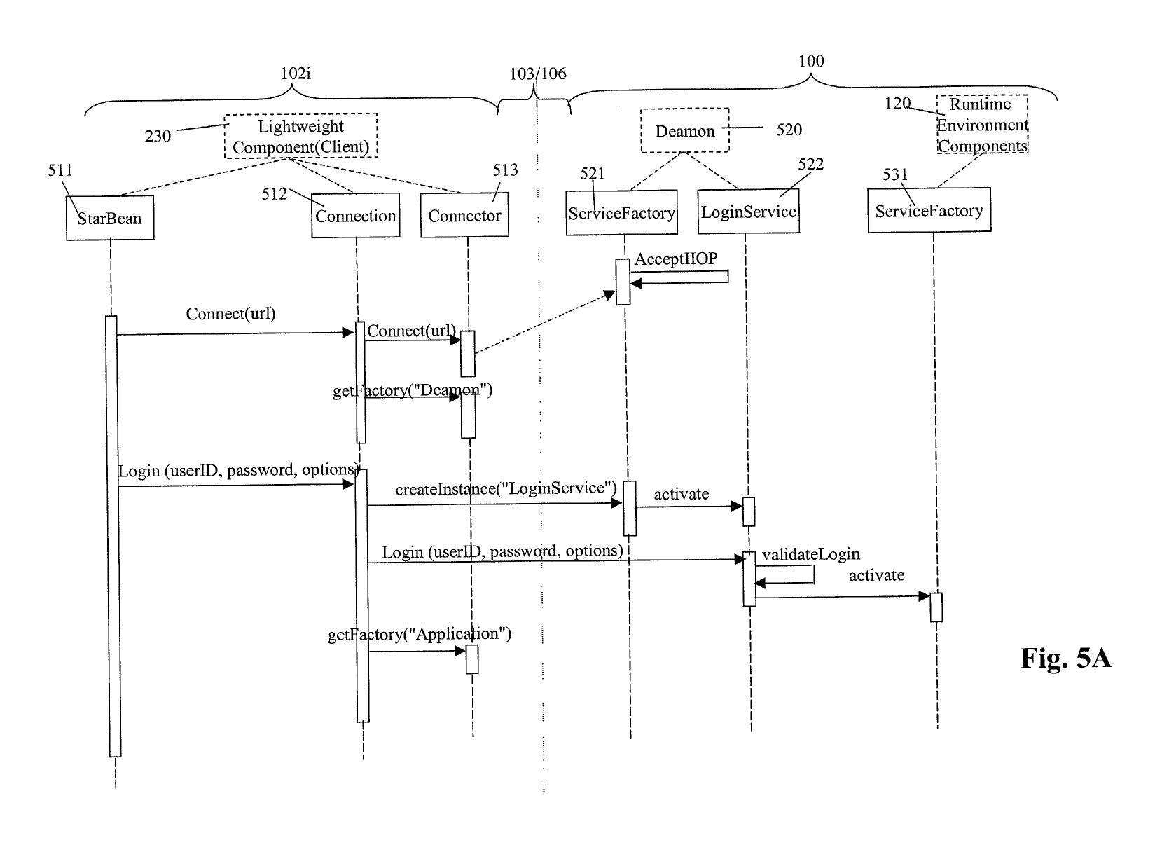

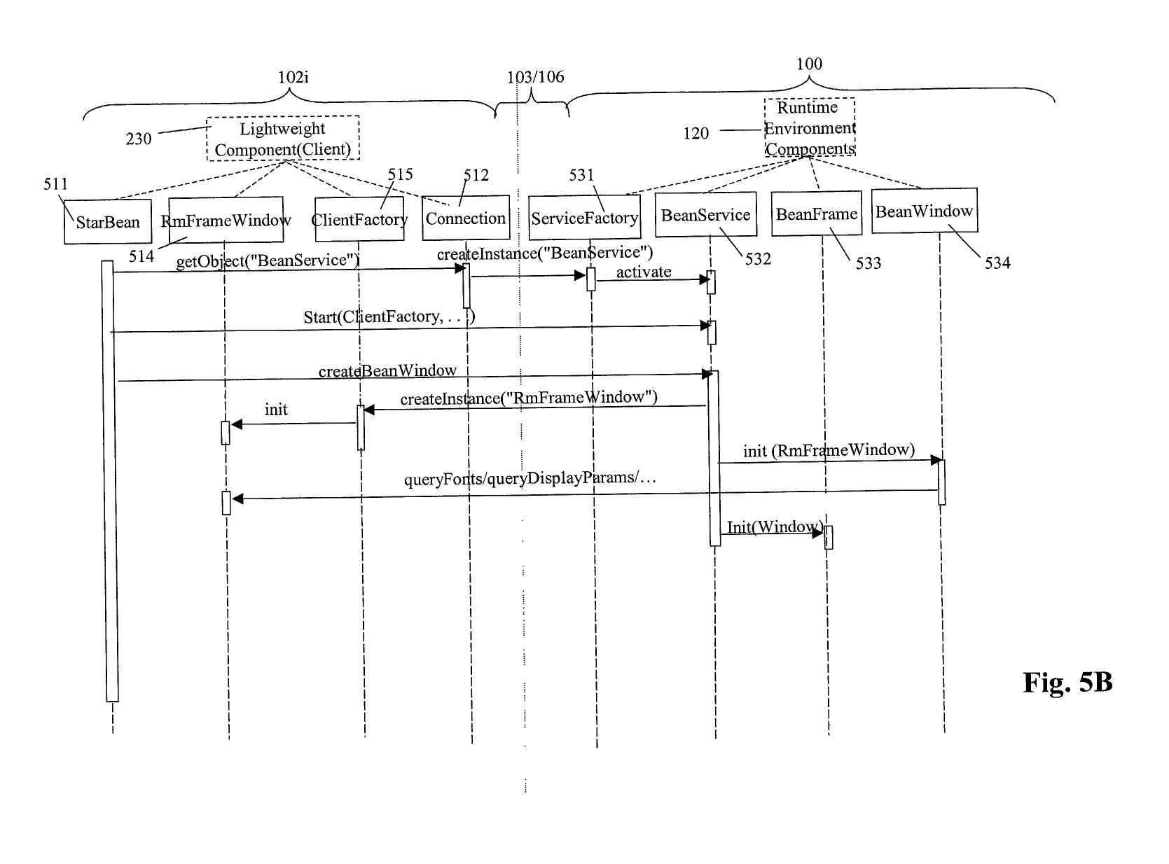

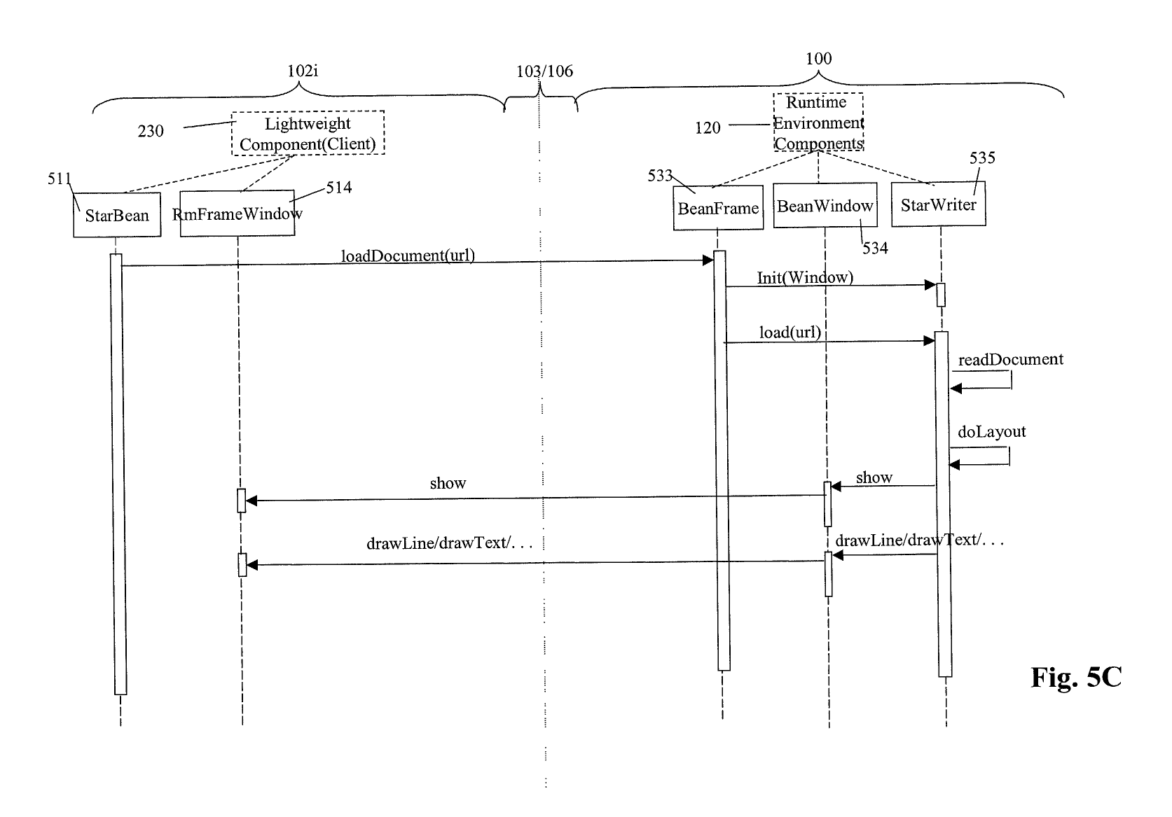

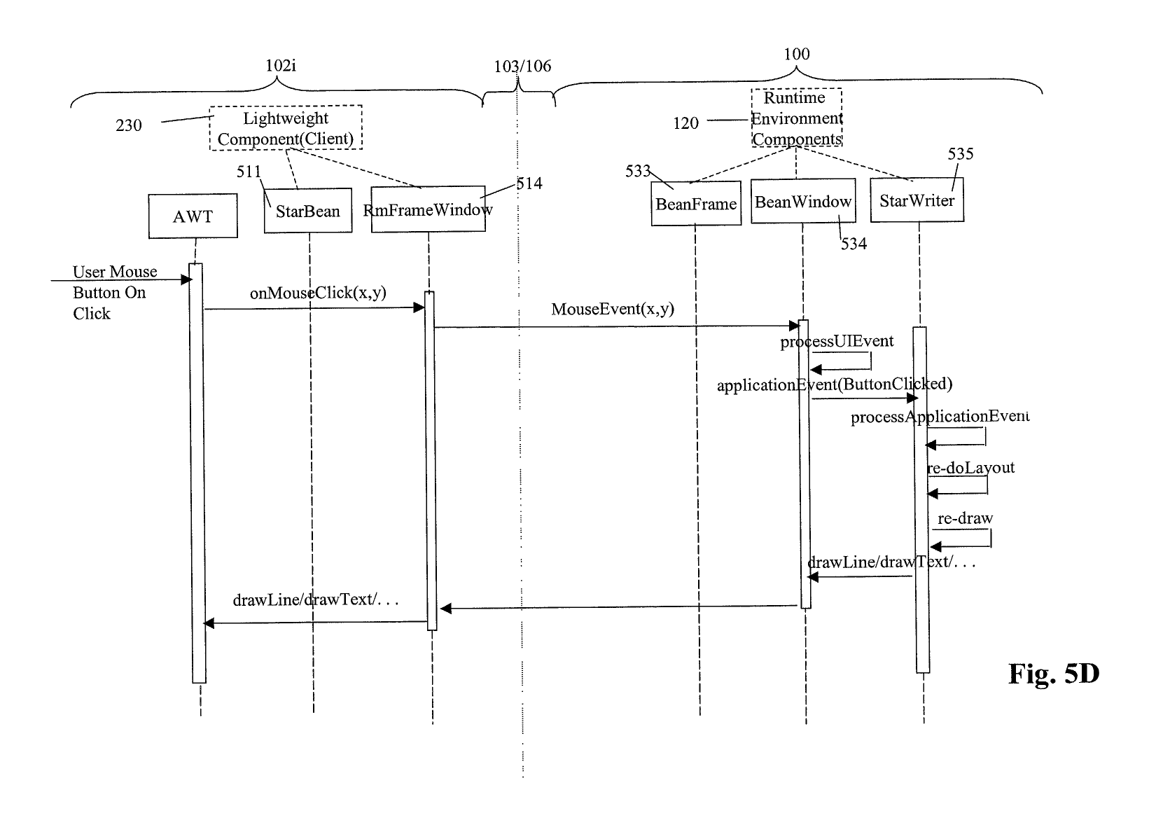

FIGS. 5A to 5D are a sequence diagram for one embodiment the present invention. Along the horizontal axis are individual objects, where each object is represented as a labeled rectangle. For convenience, only the objects needed to explain the operation are included in each Figure. The vertical axis represents the passage of time from top to bottom of the page. Horizontal lines represent the passing of messages between objects. A dashed line extends down from each rectangle, and a rectangle along the dashed line represents the lifetime of the object. Moreover, brackets are used to show which objects exist on client device 102i and which objects exist on server 100.

In one embodiment, lightweight component 230 is embedded in a graphical environment that includes a display software program with a graphical user interface (GUI). The graphical user interface is referred to as a panel. An example of one implementation is a Java bean, which is embedded in an HTML page and rendered by a browser. This Java bean represents a view (in a window) of an office application component (e.g. STAROFFICE Writer) or another visual office component. In this environment, the user is using a browser on user device 102i that utilizes the JAVA Abstract Window Toolkit (AWT). In another embodiment, a native C-programming language plug-in is used in the browser on user device 102i to implement this invention. As is known to those of skill in the art, the AWT is a set of JAVA classes and interfaces that are mapped to a concrete implementation on each different platform. The sequence displayed in FIGS. 5A to 5D is for a JAVA-enabled system.

When the user requests an application on the server, a JAVA bean, an object StarBean 511, is instantiated. Object StarBean 511 automatically issues a call to a method connect in the API of an object connection 512. The call to method connect includes a URL to server 100 on which application suite 120 is located.

In response to the call to method connect, object connection 512 calls method connect in object connector 513. In this embodiment, server 100 runs a daemon process 520, sometimes called daemon 520 that includes an object ServiceFactory 521 that accepts Internet Inter-OrB Protocol (IIOP) connections. In response to the call to method connect, connector object 513 makes a connection with daemon process 520 on server 100 and stores a handle object ServiceFactory 521 of daemon 520.

Upon completion of the connection to daemon process 520, connection object 512 calls method getFactory (“Daemon”) in the API of object connector 513 to obtain the handle for object ServiceFactory 521.

Next, object StarBean 511 calls method login in the API of object Connection 512 with a user identification, a password, and options for application suite 120 on server 100, which in this embodiment is the STAROFFICE suite of components. In response to the call to method login, object Connection 512 calls method createInstance in the API of object ServiceFactory 521 of daemon 520, and specifies that an instance of the login service is needed.

Object ServiceFactory 521 instantiates object LoginService 522 by calling method activate in the API of object LoginService 522. Object ServiceFactory 521 returns a handle to object LoginService 522 to object connection 512.

Object connection 512 calls method login of object LoginService 522 with the user identification, password, and options. In response to the login call, object LoginService 522 runs method validateLogin to validate the login request. If the login request is valid, object LoginService 522 starts application suite 120 as a new process on server 100 with the rights of the user with userID. Object LoginService 522 calls method activate of the API of object ServiceFactory 531 to instantiate object ServiceFactory 531.

Finally, to proceed with creating the infrastructure needed for application suite 120 and lightweight component 230 to work together, object connection 512, sometimes called connection object 512, calls method getFactory in object connector with an argument “Application” to get the handle to object ServiceFactory 521 that in turn is stored in object Connection 512. Upon activation of object ServiceFactory 531 and return of its handle to object Connection 512, a connection is established between application suite 120 and lightweight component 230 so that the application suite 120 and lightweight component 230 can communicate directly over network 103/106.

Upon object Connection 512 returning processing to object StarBean 511, object StarBean 511 calls method getObject(“BeanService”) in the API of object Connection 512. In method getObject, connection object 512 calls method createInstance(“BeanService”) (FIG. 5B) in object ServiceFactory 531 and in turn object ServiceFactory 531 instantiates object BeanService 532 by calling method activate in the API of object BeanService 532. A handle to object BeanService 532 is returned to object StarBean 511 and is stored by object StarBean 511.

Next, object StarBean 511 calls method start in the API of object BeanService 532. A handle to object ClientFactory 515 is passed in the call to method start so that application suite 120 can create windows and any other components on client device 102i needed by application suite 120.

To create the infrastructure needed to run application suite 120 on server 100, object StarBean 512 calls method createBeanWindow of object BeanService 532. Object BeanService 532 then calls method createInstance(“RmFramewindow”) in the API of object ClientFactory 515 and object ClientFactory 515 initializes remote frame window object 514 on user device 102i.

Following creation of remote frame window object 514 on user device 102i, object BeanService 532 calls initialize method init (RmFrameWindow) to create an instance of object BeanWindow 534 to support remote frame window object 514. To further initialize object BeanWindow 534, object BeanWindow 534 sends one or more queries to object RmFrameWindow 514 to determine the display capabilities of user device 102i.

Finally, object BeanService 532 calls method init(Window) to instantiate and initialize object BeanFrame 533 for application suite 120. Object BeanFrame 533 controls the environment for this instance of application suite 120. For example, object BeanFrame 533 controls the lifetime of components of the user interface on client device 102i used by application suite 120, the loading of such components, and so on. A handle to object BeanFrame 533 is returned to and stored by object StarBean 511.

Upon receiving the handle to object BeanFrame 533, object StarBean 511 calls method loadDocument (url) in the API of object BeanFrame 533 (FIG. 5C). Here, url is an address, e.g., a uniform resource locator, of the document requested by the user. Object BeanFrame 553 can determine which component is requested in a number of ways. For example, object BeanFrame 533 can ask the underlying transport component for a content type, or perhaps look at the first few bytes of an available number. As a last resort, the extension of the address is used by object BeanFrame 533 to determine which component within application suite 120 to launch. Independent of the technique used to identify the requested runtime environment component, after identifying the component in this embodiment, object BeanFrame 533 calls method init(Window) in component StarWriter 535 in the STAROFFICE application suite.

In this embodiment, the component initialized by BeanFrame 533 must use the remote VCL and only it to handle user interface input/output. However, no other modifications are required to work in this environment. Any prior art application that works in a windowing graphic user interface could be used in place of component StarWriter so along as it included the functionality provided by the remote VCL and used only that functionality to handle user interface input/output.

After component StarWriter 535 is initialized, object BeanFrame 533 calls method load(url) in the API of component StarWriter 535. Component StarWriter 535 loads the document at the address specified in method load and performs methods readDocument and do Layout. Upon completing the window layout, component StarWriter calls method show in the API of object BeanWindow 534, and in response, object BeanWindow 534 calls method show in the API of object RemoteFrameWindow 514. Object RemoteFrameWindow 514 causes the window generated by component StarWriter 535 to be displayed on display screen 295 of user device 102i.

Similarly, as the user of user device 102i performs an input action on the information displayed, the appropriate input event is transmitted from object RmFrameWindow 514 to object BeanWindow 533 and in turn to component StarWriter 535. Conversely, each call to a method in the graphic user interface, e.g., method drawLine, method drawText, etc., is made to the API of object BeanWindow 533 and a corresponding method call is made to a method in the API of object RmFrameWindow 514 by object BeanWindow 533.

FIG. 5D is an example of the processing of a mouse click by the user. In this example, the mouse click event is handled by the AWT panel, which in turn calls method onMouseClick (x, y) of object RmFrameWindow 514. Remote frame window object 514, in response, calls method MouseEvent (x, y) of object BeanWindow 534.

Object BeanWindow 534 runs method processUIevent to determine the particular event that occurred, and calls an appropriate method in the API of component StarWriter 535. In this example, object BeanWindow 534 calls method applicationEvent (ButtonClicked) in the API of component StarWriter 535.

In response to the method call, component StarWriter 535 runs methods processApplicationEvent, re-layout, and re-draw. Method re-draw calls the appropriate methods in object BeanWindow 534 that in turns issues corresponding method calls to object RmFrameWindow.

In the embodiment of FIGS. 5A to 5D , objects 531 to 534 are an example of a user interface infrastructure that receives graphic user interface events from user device 102i, and that the runtime environment component service sends remote graphic user interface commands. Here, commands are the calls to the various methods in the interfaces of the objects. A local command is one on system 100. A remote input action command is a command sent from lightweight component 230 on user device 102i to the user interface infrastructure on system 100 in response to a user input. A remote output command is a command sent by the user interface infrastructure on system 100 to lightweight component 230 on user device 102i. Similarly, object BeanFrame 533 is an example of a local frame object, and object BeanWindow 534 is an example of a local window object. Thus, objects and actions on system 100 are considered local, while objects and actions on user device 102i are considered remote.

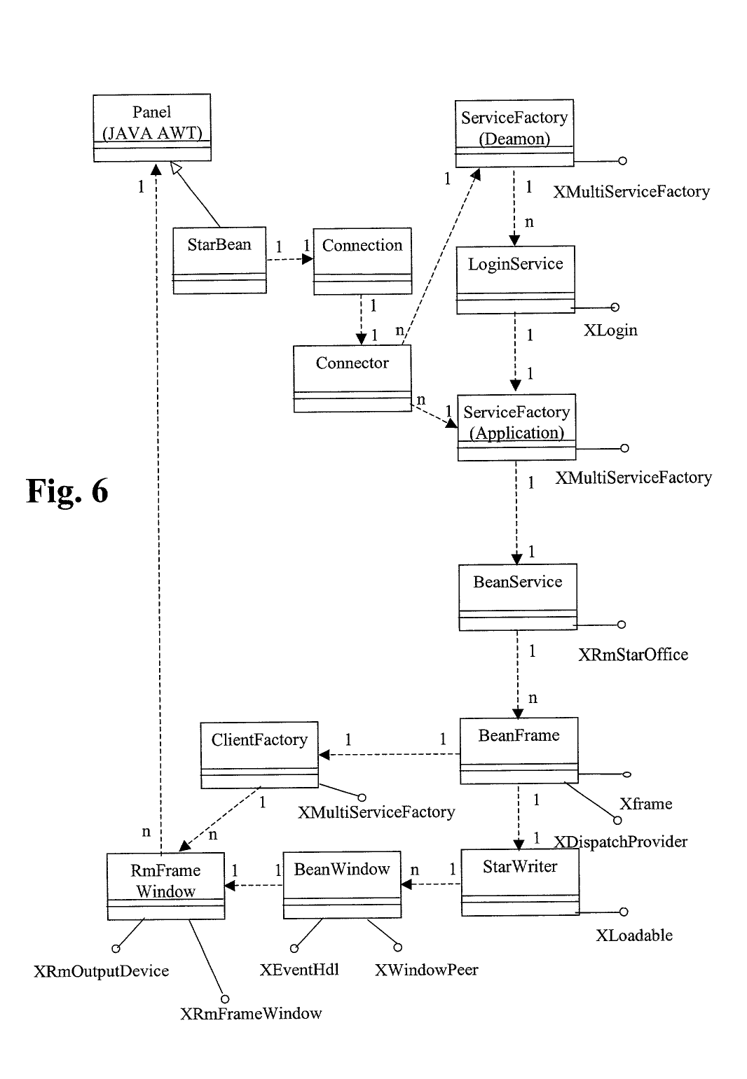

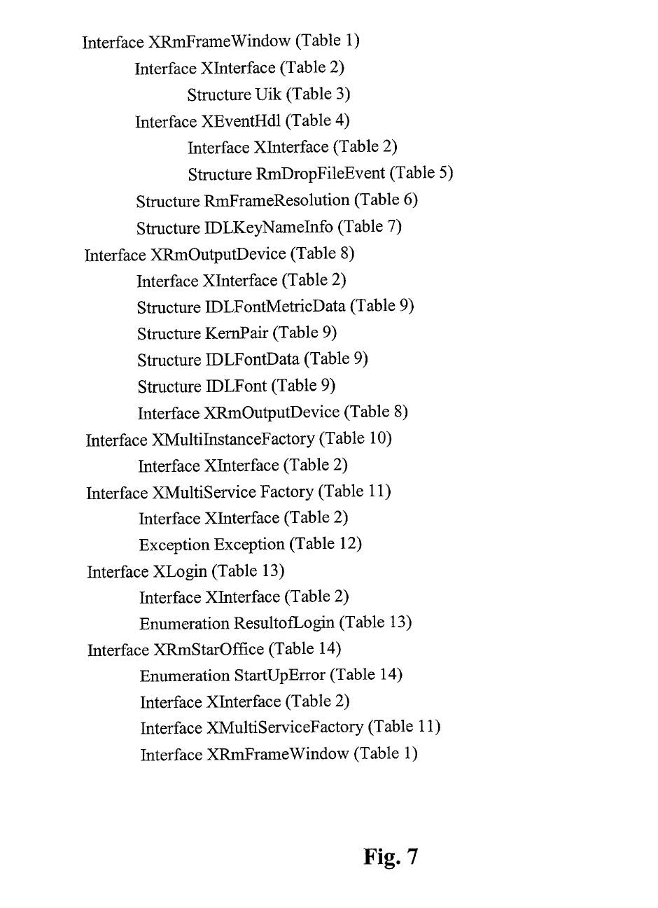

FIG. 6 is one embodiment of a class diagram for the sequence diagram of FIGS. 5A to 5D . FIGS. 7, 8A to 8C, 9, 10A and 10B illustrate one embodiment of interfaces, structures, enumerations and exceptions associated with each interface illustrated in FIG. 6 and give a corresponding Table number for each in the description that follows. The names of elements, e.g., interfaces, structures, exceptions, enumerations, strings, constants, etc., are indicative of the nature of the particular element.

In this embodiment of the invention, remote frame window class RmFrameWindow (FIG. 6) includes a remote frame window interface XRmFrameWindow (Table 1) and a remote output device interface XRmOutputDevice (Table 8). Interface XRmFrameWindow inherits from interface XInterface (Table 2 and FIG. 7) and uses interface XEventHdl (Table 4). Interface XRmFrameWindow, in the embodiment of Table 1, includes methods Create, ReleaseWindow, SetTitle, Show, SetClientSize, GetClientSize, SetWindowState, GetFontResolution, GetFrameResolutions, ToTop, StartPresentation, SetAlwaysOnTop, ShowFullScreen, CaptureMouse, SetPointer, SetPointerPos, Beep, GetKeyNames, Enable, SetIcon, SetMinClientSize, MouseMoveProcessed, and KeyInputProcessed. (Herein, an italicized phrase and the same phase that is not italicized are the same phrase.)

Method ReleaseWindow notifies the client, that the window connected to this interface is not needed by the server anymore. Whether the real window is destroyed and a new one created on the next call of Create or the real window is cached is up to the client implementation.

TABLE 1
Interface XRmFrameWindow

```
typedef sequence< IDLKeyNamelnfo, 1 > KeyNameSequence;
interface XRmFrameWindow :
    com: :sun: :star: :uno: :XInterface
{
[oneway] void Create( [in] unsigned long nWinBits,
    [in] XEventHdl xEventlntertace, [in] any
    aSystemWorkWindowToken, [in] XRmFrameWindow
    xParent ) ;
[oneway] void ReleaseWindow() ;
[oneway] void SetTitle( [in] string rTitle ) ;
[oneway] void Show( [in] boolean bVisible ) ;
[oneway] void SetClientSize( [in] short nWidth, [in]
    short nHeight ) ;
void GetClientSize( [out] short rWidth, [out] short
    rHeight ) ;
string  GetWindowState() ;
[oneway] void SetWindowState( [in] string aState ) ;
void GetFontResolution( [out] long nDPIX, [out] long
    nDPIY ) ;
RmFrameResolutions GetFrameResolutions() ;
[oneway] void ToTop( [in] unsigned short nFlags ) ;
[oneway] void Startpresentation( [in] boolean
    bStart, [in] unsigned short nStartFlags ) ;
[oneway] void SetAlwaysOnTop( [in] boolean bOnTop ) ;
[oneway] void ShowFullScreen ( [in] boolean bFullScreen) ;
[oneway] void CaptureMouse ( [in] boolean bMouse );
[oneway] void SetPointer( [in] unsigned short
    ePointerStyle ) ;
[oneway] void SetPointerPos( [in] short nX, [in] short
    nY ) ;
[oneway] void Beep( [in] unsigned short eSoundType ) ;
void GetKeyNames ( [out] KeyNameSequence rKeyNames ) ;
[oneway] void Enable ( [in] boolean bEnable ) ;
[oneway] void SetIcon( [in] short IconID ) ;
[oneway] void SetMinClientSize( [in] short Width, [in]
    short Height ) ;
[oneway] void  MouseMoveProcessed() ;
[oneway] void  KeyInputProcessed() ;
};
```

Interface XInterface (Table 2) is the base interface for other interfaces and provides lifetime control by reference counting. Interface XInterface also provides the possibility of querying for other interfaces of the same logical object. Logical object in this case means that the interfaces actually can be supported by internal, i.e., aggregated, physical objects.

Method queryInterface in interface XInterface queries for a new interface to an existing object. Method acquire increases a reference counter by one, while method release decreases the reference counter by one. When the reference counter reaches a value of zero, the object is deleted.

TABLE 2
INTERFACE XInterface

```
//=============================
interface XInterface
{
//-----------------------------------------------------------
    /** queries for a new interface to an existing
    object.
        @param aUik
          specifies the Uik of the interface to
          be queried.
        @param if c
          returns the new interface if the method
          succeeds.
        @returns
          <TRUE/> if the UNO object to which this
          interface referred supports the
          interface denoted by parameter aUik.
      */
    any queryInterface( [in] type aType ) ;
//boolean queryInterface( [in]
//com: :sun: :star: :uno: :Uik aUik,
//[out] any ifc ) ;
//-----------------------------------------------------------
    /** increases the reference counter by one.
    */
    [oneway] void acquire () ;
//-----------------------------------------------------------
    /** decreases the reference counter by one.
    When the reference counter reaches 0, the object
    gets deleted.
      */
[oneway] void release() ;
};
//==============================
```

One embodiment of structure Uik in interface XInterface is presented in Table 3.

TABLE 3
Structure Uik

//=============================
/** specifies a universal interface key.
An UIK is an unambiguous 16-byte value for every
interface.
*/
struct Uik
{
//---------------------------------------------------
// specifies a 4 byte data block.
unsigned long m_Data1;
//---------------------------------------------------
/// specifies a 2 byte data block.
unsigned short m_Data2;
//---------------------------------------------------
/// specifies a 2 byte data block.
unsigned short m_Data3;
//---------------------------------------------------
/// specifies a 4 byte data block.
unsigned long m_Data4;
//---------------------------------------------------
/// specifies a 4 byte data block.
unsigned long m_Data5;
};
//=============================

Method Create in interface XRmFrameWindow of class RmFrameWindow (FIG. 6) includes as an input a reference to an event handler interface XEventHdl (Table 4). Class BeanWindow (FIG. 6) also uses event handler interface XEventHdl. In this embodiment, interface XEventHdl inherits from interface XInterface (Table 2) and uses a structure RmDropFileEvent (Table 5). Interface XEventHdl includes methods MouseButtonUp, MouseButttonDown, MouseMove, MouseWheel, KeyInput, KeyUp, Paint, Resize, GetFocus, LoseFocus, Close, QueryDropFile, DropFile, and UserEvent.

One embodiment of structure RmDropFileEvent that is passed in the call to method RmDropFileEvent is presented in Table 5.

TABLE 4
INTERFACE XEventHdl

```
interface XEventHdl : com: :sun: :star: :uno: :XInterface
{
[oneway] void MouseButtonUp( [in] short nX, [in] short
    nY, [in] unsigned short nMode, [in] unsigned short
    nCode, [in] unsigned long nSysTime ) ;
[oneway] void MouseButtonDown( [in] short nX, [in]
    short nY, [in] unsigned short nMode, [in] unsigned
    short nCode, [in] unsigned long nSysTime ) ;
[oneway] void MouseMove( [in] short nX, [in] short nY,
    [in] unsigned short nMode, [in] unsigned short
    nCode, [in] unsigned long nSysTime ) ;
[oneway] void MouseWheel( [in] long nX, [in] long nY,
    [in] unsigned short nCode, [in] unsigned long
    nSysTime , [in] long nDelta, [in] long
    nNotchDelta, [in] unsigned long nScrollLines, [in]
    boolean bHorz) ;
[oneway] void KeyInput( [in] unsigned short nKeyCode,
    [in] unsigned short nChar, [in] unsigned short
    nCount ) ;
[oneway] void Keyup( [in] unsigned short nKeyCode,
    [in] unsigned short nChar ) ;
[oneway] void Paint( [in] long nX, [in] long nY, [in]
    long nWidth, [in] long nHeight ) ;
[oneway] void Resize( [in] short nWidth, [in] short
    nHeight ) ;
[oneway] void GetFocus() ;
[oneway] void LoseFocus() ;
boolean  QueryDropFile( [inout]
    RmDropFileEvent rDropFileEvent ) ;
boolean  DropFile( [in] RmIDropFileEvent
    aDropFileEvent ) ;
[oneway] void Close() ;
[oneway] void UserEvent( [in] unsigned long EventID,
    [in] any Parameter ) ;
};
```

TABLE 5
Structure RmDropFileEvent

typedef sequence < string > FileNameSequence;
struct RmDropFileEvent
{

| | |
|---|---|
| short | nX; |
| short | nY; |
| FileNameSequence | aFileNameSequence; |
| unsigned short | nDropAction; |
| unsigned short | nSourceOptions; |
| byte | nWindowType; |
| boolean | bIsDefault; |

};

Structures used in interface XRmFrameWindow (Table 1 and FIG. 7) include structure RmFrameResolutions (Table 6) and structure IDLKeyNameInfo (Table 7).

TABLE 6
Structure RmFrameResolutions

struct RmFrameResolutions
{
long DPIx;
long DPIy;
long FontDPIx;
long FontDPIy;
unsigned short Depth;
};

TABLE 7
Structure IDLKeyNamelnfo

```
struct IDLKeyNameInfo
{
    unsigned short  nCode;
    string  aName;
};
```

As illustrated in FIG. 6, class RmFrameWindow includes remote output device interface XRmOutputDevice (Table 8). Interface XRmOutputDevice inherits from interface XInterface (Table 2), and uses structures IDLFontMetricData, KernPair, IDLFontData, IDLFont (Table 9). In the embodiment of Table 8, interface XRmOutputDevice includes methods QuerySvOutputDevicePtr, SetClipRegion, ResetClipRegion, GetResolution, GetCharWidth, GetFontMetric, GetKernPairs, GetDevFontList, AddFontAtom, GetGlyphBoundRect, GetGlyphOutline, GetPixel, GetPixelArray, SetFont, SetTextColor, SetLineColor, SetFillColor, SetRasterOp, CopyArea, CopyBits, Invert, InvertPolygon, InvertTracking, InvertTrackingPolygon, DrawPixel, DrawColoredPixel, DrawPixelArray, DrawLine, DrawRect, DrawPolyLine, DrawPolygon, DrawPolyPolygon, DrawEllipse, DrawArc, DrawPie, DrawCord, DrawGradient, DrawPolyPolyGradient, DrawPolyPolyHatch, DrawText, DrawTextArray, DrawWaveLine, DrawGrid, DrawPolyPolyTransparent, and Draw2ColorFrame.

TABLE 8
Interface XRmOutputDevice

```
interface XRmOutputDevice :
    com: :sun: :star: :uno: :XInterface
{
unsigned long QuerySvOutputDevicePtr() ;
[oneway] void SetClipRegion( [in] ByteSequence aData
    ) ;
[oneway] void ResetClipRegion() ;
void GetResolution( [out] long nDPTX, [out] long
    nDPIY, [outi unsigned short nBitCount ) ;
sequence< long > GetCharWidth( [in] unsigned short
    nStart, [in] unsigned short nEnd ) ;
void GetFontMetric ([out] IDLFontMetricData
    rFontMetric, [in] unsigned short nFirstChar, [in]
    unsigned short nLastCar, [in] boolean
    bGetKernPairs ) ;
sequence< KernPair > GetKernPairs() ;
void GetDevFontList( [out] sequence< string >
    FontNameAtoms, [out] sequence< string >
    StyleNameAtoms, [out] IDLFontDataSequence
    rFontData ) ;
[oneway] void AddFontAtom( [in] byte Type, [in] string
    Name, [in] unsigned short Atom ) ;
boolean GetGlyphBoundRect( [in] unsigned short cChar,
    [out] long nX, [out] long nY, [out] long nWidth,
    [out] long nHeight, [in] boolean bOptimize ) ;
boolean GetGlyphOutline( [in] unsigned short cChar,
    [out] ByteSequence rPoly, [in] boolean bOptimize
    );
void GetPixel( [in] long nX, [in] long nY, [out]
    unsigned long nColor ) ;
void GetPixelArray( [in] ByteSequence aData, [out]
    ULongSequence aColors ) ;
[oneway] void SetFont ( [in] IDLFont aFont ) ;
[oneway] void SetTextColor( [in] unsigned long nColor
    );
[oneway] void SetLineColor( [in] unsigned long nColor
    );
[oneway] void SetFillColor( [in] unsigned long nColor
    );
[oneway] void SetRasterOp( [in] unsigned short nROP ) ;
[oneway] void CopyArea( tin] long nSrcX, [in] long
    nSrcY, [in] long nSrcWidth, [in] long
    nSrcHeight, [in] long nDestX, [in] long nDestY,
    [in] unsigned short nFlags ) ;
[oneway] void CopyBits( [in] long nSrcX, [in] long
    nSrcY, [in] long nSrcWidth, [in] long nSrcHeight,
    [in] long nDestX, [in] long nDestY, [in] long
    nDestWidth, [in] long nDestHeight, [in]
    XRmOutputDevice xFrom ) ;
[oneway] void Invert( [in] long nX, [in] long nY, [in]
    long nWidth, [in] long nHeight, [in] unsigned
    short nFlags ) ;
[oneway] void InvertPolygon( [in] ByteSequence
    aPolygon, [in] unsigned short nFlags ) ;
[oneway] void InvertTracking( [in] long nX, [in] long
    nY, [in] long nWidth, [in] long nHeight, [in]
    unsigned short nFlags ) ;
[oneway] void InvertTrackingPolygOn( [in] ByteSequence
    aPolygon, [in] unsigned short nFlags ) ;
[oneway] void DrawPixel ( [in] long nX, [in] long nY ) ;
[oneway] void DrawColoredPixel( [in] long nX, [in]
    long nY, [in] unsigned long nColor ) ;
[oneway] void DrawPixelArray( [in] ByteSequence aData,
    [in] ULongSequence aColors ) ;
[oneway] void DrawLine( [in] long nStartX, [in] long
    nStartY, [in] long nEndX, [in] long nEndY ) ;
[oneway] void DrawRect( [in] long nX, [in] long nY,
    [in] long nWidth, [in] long nHeight ) ;
[oneway] void DrawPolyLine( [in] ByteSequence aData ) ;
[oneway] void DrawPolygon( [in] ByteSequence aData ) ;
[oneway] void DrawPolyPolygon( [in] ByteSequence aData );
[oneway] void DrawRoundedRect( [in] long nX, [in] long
    nY, [in] long nWidth, [in] long nHeight, [in]
    unsigned long nHorzRound, [in] unsigned long
    nVertRound ) ;
[oneway] void DrawEllipse( [in] long nX, [in] long nY,
    [in] long nWidth, [in] long nHeight ) ;
[oneway] void DrawArc( [in] long nX, [in] long nY,
    [in] long nWidth, [in] long nHeight, [in] long
    nStartX, [in] long nStartY, [in] long nEndX, [in]
    long nEndY ) ;
[oneway] void DrawPie( [in] long nX, [in] long nY,
    [in] long nWidth, [in] long nHeight, [in] long
    nStartX, [in] long nStartY, [in] long nEndX, [in]
    long nEndY ) ;
[oneway] void DrawChord( [in] long nX, [in] long nY,
    [in] long nWidth, [in] long nHeight, [in] long
    nStartX, [in] long nStartY, [in] long nEndX, [in]
    long nEndY ) ;
[oneway] void DrawGradient( [in] long nX, [in] long
    nY, [in] long nWidth, [in] long nHeight, [in]
    ByteSequence aData ) ;
[oneway] void DrawPolyPolyGradient( [in] ByteSequence
    aPolyPolyData, [in] ByteSequence aGradientData ) ;
[oneway] void DrawPolyPolyHatch( [in] ByteSequence
    aPolyPolyData, [in] ByteSequence aHatchData ) ;
[oneway] void DrawText( [in] long nX, [in] long nY,
    [in] string aText ) ;
[oneway] void DrawTextArray( [in] long nX, [in] long
    nY, [in] string aText, [in] LongSequence aLongs ) ;
[oneway] void DrawWaveLine( [in] long nStartX, [in]
    long nStartY, [in] long nEndX, [in] long nEndY,
    [in] unsigned short nStyle ) ;
[oneway] void DrawGrid( [in] long nMinX, [in] long
    nMaxX, [in] sequence< long > aHorzValues, [in]
    long nMinY, [in] long nMaxY, [in] sequence< long
    > aVertValues, [in] unsigned long nFlags ) ;
[oneway] void DrawPolyPolyTransparent( [in]
    ByteSequence aData, [in] unsigned short
    nTransparencyPercent ) ;
[oneway] void Draw2ColorFrame( [in] long x, [in] long
    y, [in] unsigned long width, [in] unsigned long
    height, [in] unsigned long leftAndTopColor, [in]
    unsigned long rightAndBottomColor ) ;
};
```

In one embodiment, method GetFontMetric (Table 8) gets the general metrics of the current font. If the value of inputs nFirstChar and nLastChar are not equal, member maCharWidths of output structure IDLFontMetricData (Table 9) is filled as it would be in a call by method GetCharWidth and so saves one synchronous call. If the Boolean input value of variable bGetKernPairs is true, member maKerningPairs of output structure IDLFontMetricData is filled as it would be in a call to method GetKernPairs, and this saves another synchronous call.

In method AddFontAtom, Type is a FontAtomType; Name is the new atom string; and Atom the new atomic value

In Table 9, a brief description of given of the values in the various structures.

TABLE 9
Structure and Other Information Used by
Interface XRmOutputDevice

```
// [in] Eingabe-Parameter. Der “Server” auf dem das
Object liegt // ist der Remote-Client.
// Also “Server” eigentlich “Display”
// [oneway] => Kein warten auf Antwort
struct KernPair
{
    unsigned short  Char1;
    unsigned short  Char2;
    short  Kerning;
};
struct IDLFontMetricData
{
// these data must be set
// Durchschnittsbreite vom Font in Pixeln (must same as
by SetFont)
short  mnWidth;
// Ascent
short  mnAscent;
// Descent
short  mnDescent;
// Internal-Leading
short  mnLeading;
// Schraegstellung (bei Italic)
short  mnSlant;
// Erstes druckbare Zeichen im Font
unsigned short  mnFirstChar;
// Letztes druckbare Zeichen Pu Font
unsigned short  mnLastChar;
// this data should be overwritten
// Fontname: Atom
unsigned short  mnName;
// Stylename: Atom
unsigned short  mnStyleName;
// Rotation
short  mnOrientation;
// Family vom Font
byte  meFamily;
// CharSet vom Font
byte  meCharSet;
// Weight vom Font
byte  meWeight;
// Italic vom Font
byte  meItalic;
// Pitch vom Font
byte  mePitch;
// Type vom Font
byte  meType;
// Ist es ein Device-Font
boolean  mbDevice;
// factor for charwidths
long  mnFactor;
sequence< long >  maCharWidths;
sequence<KernPair > maKerningPairs;
};
struct IDLFontData
{
// Struktur zum Abfragen der DevFontList
// Name vom Font: Atom
unsigned short  mnName;
// StyleName vom Font: Atom
unsigned short  mnStyleName;
// Breite vom Font in Pixein
short  mnWidth;
// Heoehe vom Font in Pixeln
short  mnHeight;
// Family vom Font
byte  meFamily;
// CharSet vom Font
byte  meCharSet;
// Pitch vom Font
byte  mePitch;
// WidthType vom Font
byte  meWidthType;
// Weight vom Font
byte  meWeight;
// Italic vom Font
byte  meItalic;
// Type vom Font
byte  meType;
// bit0: mborientation
// bit 1: mbDevice
byte  mnBools;
};
struct IDLFont
{
// Struktur zum Setzen eines Fonts...
unsigned short  mnName;
unsigned short  mnStyleName;
short  mnWidth;
short  mnHeight;
byte  meFamily;
byte  meCharSet;
byte  meWidthType;
byte  meWeight;
byte  meltalic;
byte  mepitch;
short  mnOrientation;
};
typedef sequence< byte, 1 > ByteSequence;
typedef sequence< long, 1 > LongSequence;
typedef sequence< unsigned long, 1 > ULongSequence;
typedef sequence< unsigned short , 1 > UShortSequence;
typedef sequence< IDLFontData, 1 > IDLFontDataSequence;
constants FontAtomType
{
    const byte NAME = 0;
    const byte STYLE = 1;
};
```

In FIG. 6, class ClientFactory includes interface XMultiInstanceFactory (Table 10 and FIG. 7). Class ClientFactory is called by an object BeanFrame to generate multiple instances of class RmFrameWindow. Interface XMultiInstanceFactory inherits from interface XInterface (Table 2).

TABLE 10
INTERFACE XMultiInstanceFactory

```
interface XMultilnstanceFactory
    com: :sun: :star: :uno: :XInterface
{
sequence<any> createInstances (
      [in] string aObjectName,
      [in] long nCount) ;
};
```

In FIG. 6, class ServiceFactory include interface XMultiServiceFactory (Table 11 and FIG. 7). Class ServiceFactory is called by an object connector to generate objects LoginService and BeanService. Interface XMultiServiceFactory inherits from interface XInterface (Table 2) and throws an exception Exception (Table 12).

TABLE 11
INTERFACE XMultiServiceFactory

```
interface XMultiServiceFactory:
    com: :sun: :star: :uno: :XInterface
{
com: :sun: :star: :uno: :XInterface createInstance( [in]
    string aServiceSpecifier )
    raises( com: :sun: :star: :uno: :Exception ) ;
com: :sun: :star: :uno: :XInterface
    createInstanceWithArguments(
        [in] string ServiceSpecifier,
        [in] sequence<any> Arguments )
raises( com: :sun: :star: :uno: :Exception ) ;
sequence<string> getAvailableServiceNames();
};
```

The service factory objects support this interface for creating components by a specifying string, i.e. the service name. In the embodiment of Table 11, interface XMultiServiceFactory includes methods createInstance, createInstanceWithArguments, and getAvailableServiceNames.

Method createInstance creates an instance of a component which supports the services specified by the factory. Input parameter ServiceSpecifier is a service name that specifies the service that should be created by this factory

Method createInstanceWithArguments creates an instance of a component which supports the services specified by the factory. Input parameter aArguments is the values of the arguments that depend on the service specification of the factory. Normally the factory delegates the arguments to the method init ( ) of the created instance. The factory is explicitly allowed to modify, delete or add arguments. The conversion rules of the arguments are specified by a converter service. Input parameter ServiceSpecifier is a service name that specifies the service that should be created by this factory.

Method getAvailableServiceNames returns a sequence of all service identifiers, which can be instantiated.

Table 12 presents one embodiment of exception Exception that is used by interface XMultiServiceFactory.

TABLE 12
EXCEPTION Exception

exception Exception
{
string Message;
com: :sun: :star: :uno: :XInterface Context;
};

In this embodiment, exception Exception is the basic exception from which all other exceptions are derived. Parameter Message specifies a detailed message of the exception or an empty string if the callee does not describe the exception. Context is an object that describes the reason for the exception. Object Context may be NULL if the callee does not describe the exception.

Service LoginService that is instantiated by object ServiceFactory of the daemon includes an interface XLogin (Table 13 and FIG. 7). Interface XLogin inherits from interface XInterface and uses an enumeration ResultofLogin.

TABLE 13
INTERFACE XLogin

```
enum ResultofLogin
{
    OK,
    NO_LICENSE,
    ALREADY_LOGGED_IN,
    SECURITY_VIOLATION,
    COULD_NOT_TO_FILESERVER,
    NO_CONFIGURATION,
    UNKNOWN_ERROR
    };
interface XLogin: com: :sun: :star: :uno: :XInterface
{
Boolean installationHasBeenCompleted ( [in] string
    sNameOfUser ) ;
void completeInstallation ( [in] string sNameOfUser,
    [in] string sPassword ) ;
ResultofLogin login ( [in] string sNameOfUser, [in]
    string sPassword, [in] string sNameOfWorkstation,
    [in] string sParameter ) ;
string getQualifiedNameOfUser ( [in] string
    sNameOfUser ) ;
};
```

In the embodiment of Table 13, interface XLogin includes methods installationHasBeenCompleted, completeInstallation, login, and getQualifiedNameOfUser.

Class BeanService includes an interface XRmStarOffice in the embodiment of FIG. 6. One embodiment of interface XRmStarOffice is presented in Table 14. Interface XRmStarOffice inherits from interface XInterface and uses interfaces XMultiServiceFactory (Table 11) and XRmFrameWindow (Table 1). See FIG. 7.

TABLE 14
INTERFACE XRmStarOffice

```
typedef enum _StartUpError {
    SOFFICE_NO_ERROR,
    SOFFICE_WRONG_LOGIN,
    SOFFICE_SERVICE_NOT_FOUND,
    SOFFICE_CONNECTION_REFUSED,
    SOFFICE_NO_LICENSE,
    SOFFICE_UNKNOWN_ERROR,
    SOFFICE_ALREADY_STARTED
} StartUpError;
constants StarOfficeServerType
{
    const long APPSERVER = 0;
    const long BEANSERVER = 1;
    const long ONESERVER = 2;
};
interface XRmStarOffice :
    com: :sun: :star: :uno: :XInterface
{
/** AppName+Params+Version+Language, weil ueber den
Demon dann spaeter auch andere Programme gestartet
werden koennen...
*/
StartupError  Start (
    [in] com: :sun: :star: :lang: :XMultiServiceFactory
        xClientFactory,
    [in] string aConnectionName,
    [in] string aUserName,
    [in] string aPassword,
    [in] string aFileServer,
    [in] string  aClientSystemName,
    [in] string  aAppName,
    [in] string  aAppParams,
    [in] unsigned long nAppLanguage,
    [in] unsigned long nRemoteVersion,
    [in] long servertype
) ;
[oneway] void SetUserInfoForPrinting(
    [in] string AuserName,
    [in] string aPassword ) ;
void  AddRemotePrinter(
    [in] string aName,
    [in] string aServer,
    [in] boolean bSetAsDefault,
    [in] boolean bIsLocal ) ;
com: :sun: :star: :uno: :XInterface CreateBeanWindow(
    [in] XRmFrameWindow xFrameWin,
    [in] com: :sun: :star: :lang: :XMultiServiceFactory
            xClientFactory,
    [in] any aSystemWindowToken ) ;
};
```

In the embodiment of Table 14, interface XRmStarOffice includes methods Start, SetUserInfoForPrinting, AddRemotePrinter, and CreateBeanWindow. Method start receives as input a reference to object ClientFactory, a user name, a password, identification of a file server, and a specification of the application that is to be started, e.g., parameters application name, application parameters, application language, and version. Method CreateBeanWindow receives a reference to object RmFrameWindow, and object ClientFactory as inputs.

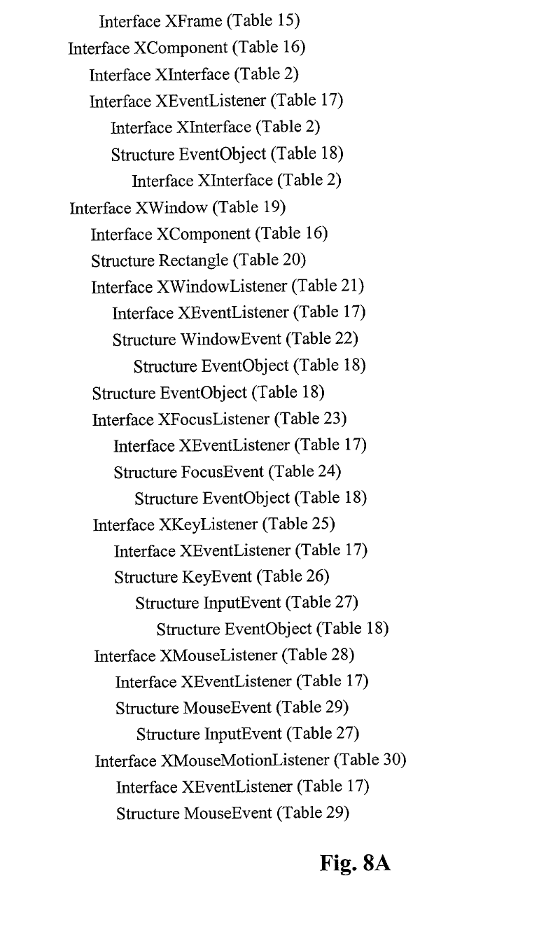

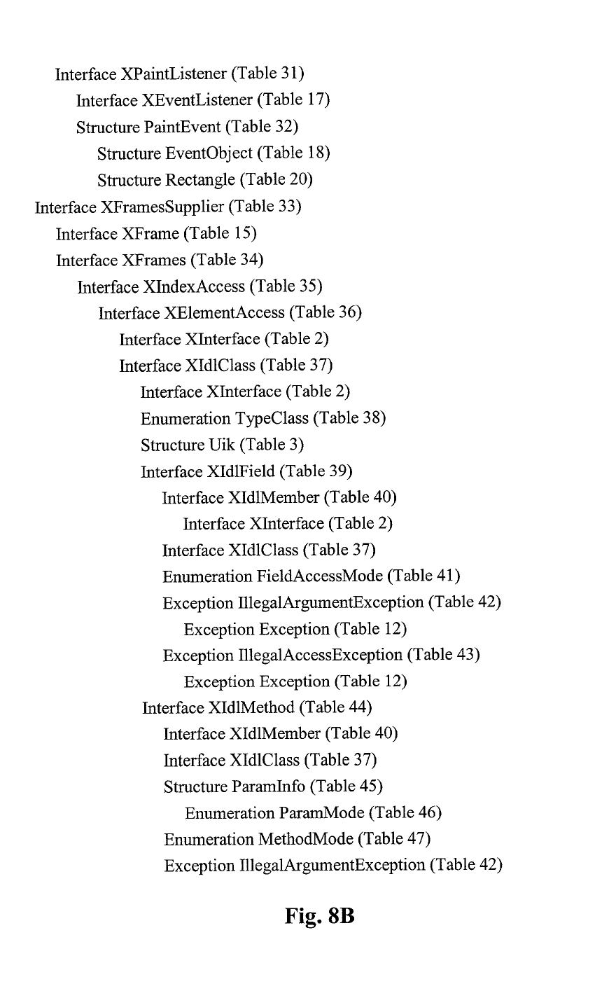

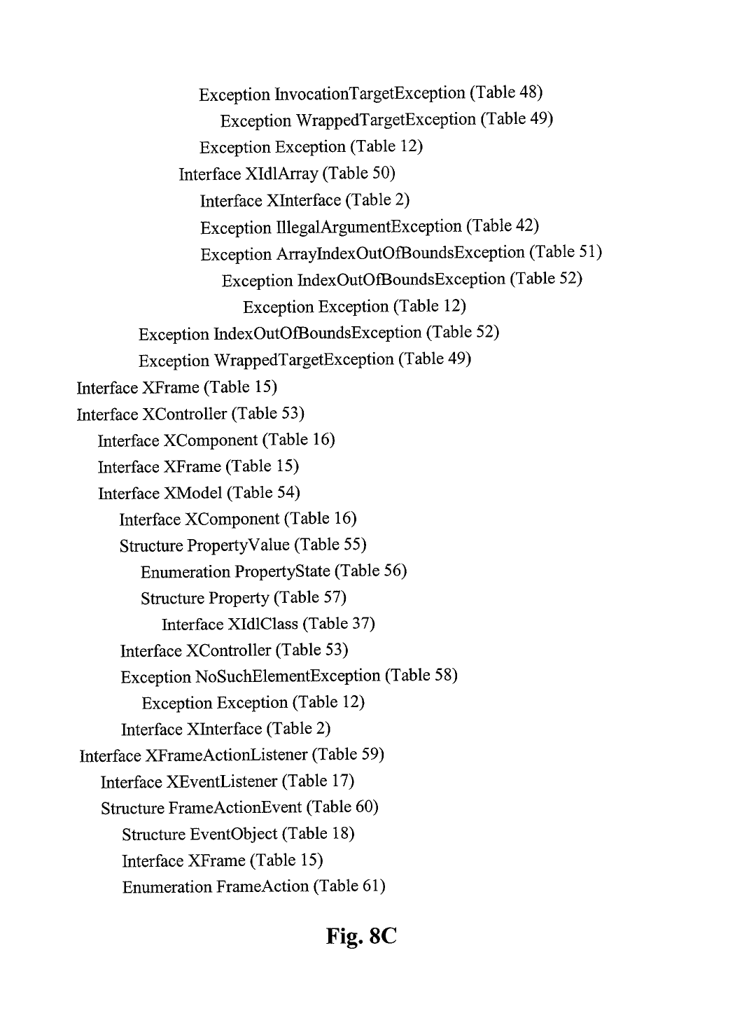

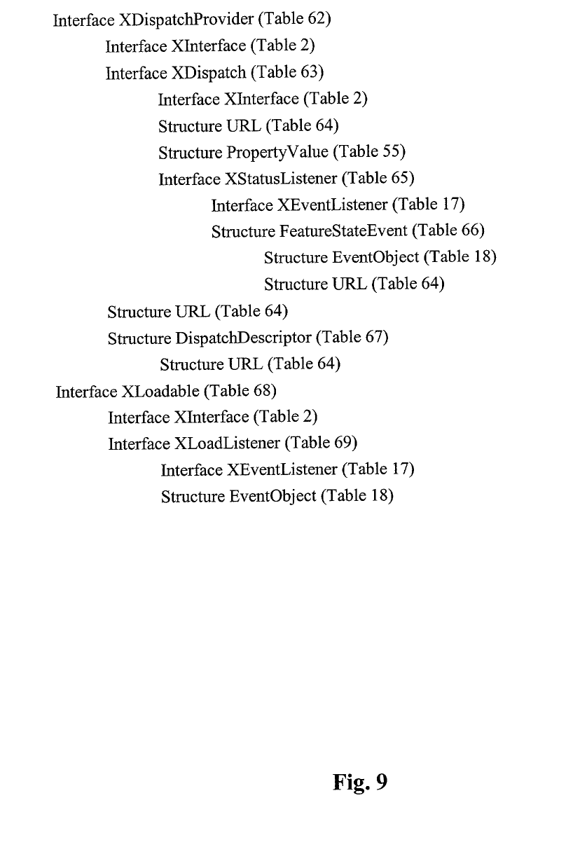

Class BeanFrame (FIG. 6) includes two interfaces, interface XFrame (Table 15) and interface XDispatchProvider (Table 62 and FIG. 9). In the embodiment of Table 15, interface XFrame inherits from interface XComponent (Table 16). Interface XFrame uses interfaces XWindow (Table 19), XController (Table 53 and FIG. 8C), and XFrameActionListener (Table 59 and FIG. 8C). As illustrated in FIGS. 8A to 8C, each of these interfaces uses other interfaces, structures, exceptions, and enumerations that are described more completely below.

In the embodiment of Table 15, interface XFrame includes methods initialize, setCreator, getcreator, getName, setName, findFrame, isTop, activate, deactivate, setComponent, getComponentWindow, getController, contextChanged, addFrameActionListener, and removeFrameActionListener

TABLE 15
INTERFACE XFRAME

```
interface XFrame: com: :sun: :star: :lang: :XComponent
{
void initialize( [in] com: :sun: :star: :awt: :XWindow
    xWindow ) ;
com: :sun: :star: :awt: :XWindow getContainerWindow() ;
[oneway] void setCreator(
    [in] XFramesSupplier xCreator ) ;
[const] XFramesSupplier getCreator() ;
[const] string getName() ;
[oneway] void setName ( [in] string aName ) ;
com: :sun: :star: :frame: :XFrame findFrame( [in] string
    aTargetFrameName, [in] long nSearchFlags ) ;
boolean isTop() ;
[oneway] void activate() ;
[oneway] void deactivate() ;
boolean isActive() ;
boolean setComponent ( [in] com: :sun: :star: :awt: :XWindow
    xComponentWindow, [in]
    com: :sun: :star: :frame: :XController xController ) ;
[const] com: :sun: :star: :awt: :XWindow
    getComponentWindow() ;
[const] XController getController() ;
void contextChanged() ;
[oneway] void addFrameActionListener(
    [in] XFrameActionListener xListener ) ;
[oneway] void removeFrameActionListener( [in]
    XFrameActionListener xListener ) ;
};
```

Interface XFrame makes it possible to control a frame. Method initialize is called to initialize the frame within a window. Method getContainerWindow provides access to the window of the frame. Normally this is used as the parent window of the controller window. Method setCreator sets the frame container that created this frame. Only the creator is allowed to call method setCreator. Method getcreator returns the frame container that created this frame. Method getName returns the programmatic name of this frame. Method setName sets the name of the frame. Normally, the name of the frame is set initially.

Method findFrame searches for a frame with the specified name. Frames may contain other frames, e.g., a frameset, and may be contained in other frames. This hierarchy is searched with this method. First some special names are taken into account, i.e. “ ”,“_self”, “_top”, “_active” etc., flag nSearchFlags is ignored when comparing these names with parameter aTargetFrameName, and further steps are controlled by flag nSearchFlags. If allowed, the name of the frame itself is compared with the desired one, then (again, if allowed )the method is called for all children of the frame. Finally, the method may be called for the parent frame (if allowed). If no frame with the given name is found, a new top frame is created if this is not suppressed by a special value of flag FrameSearchFlag. The new frame also gets the desired name.

Method isTop determines if the frame is a top frame. In general, a top frame is the frame which is a direct child of a task frame or which does not have a parent. If a frame returns for this method, all calls have to stop the search at such a frame unless the flag FrameSearchFlag:: TASKS is set.

Method activate activates this frame and thus the component within. At first, the frame sets itself as the active frame of its creator by calling FrameAction:: FRAME_ACTIVATED. The component within this frame may listen to this event to grab the focus on activation. For simple components, this can be done by a Frame Loader. Finally, most frames may grab the focus to one of its windows or forward the activation to a sub-frame.

Method deactivate is called by the creator frame when another sub-frame is activated. At first the frame deactivates its active sub-frame, if any, and then broadcasts a Frame Action Event with FrameAction:: FRAME_DEACTIVATING.

Method isActive determines if the frame is active. Method setComponent sets a new component into the frame. Method getComponentWindow returns the current visible component in this frame. The frame is the owner of the window. Method getController returns the current controller within this frame. Normally, it is set by a frame loader.

Method contextChanged notifies the frame that the context of the controller within this frame changed (i.e. the selection). According to a call to this interface, the frame calls with FrameAction:: CONTEXT_CHANGED to all listeners, which are registered using this frame. For external controllers, this event can be used to requery dispatches.

Method addFrameActionListener registers an event listener, which is called when certain things happen to the components within this frame or within sub-frames of this frame. For example, it is possible to determine instantiation/destruction and activation/deactivation of components. Method removeFrameActionListener unregisters an event listener, which was registered with addFrameActionListener ( ).

Interface XFrame inherits from interface XComponent. One embodiment of interface XComponent is presented in Table 16. Interface XComponent inherits from interface XInterface (Table 2) and uses interface XEventListener that in turn uses structure EventObject. See FIG. 8A.

TABLE 16
INTERFACE XComponent

interface XComponent: com: :sun: :star: :uno: :XInterface
{
void disposer() ;
void addEventListener( [in] XEventListener xListener ) ;
void removeEventListener(
[in] XEventListener aListener ) ;
};

Interface XComponent controls the lifetime of components. Actually the real lifetime of an object is controlled by references kept on interfaces of the object. There are two distinct meanings in keeping a reference to an interface: first is to own the object; and second is to know the object.

To prevent cyclic references from resulting in failure to destroy an object, references of interfaces to the object are allowed only (i) by the owner, (ii) if the reference is very temporary, or (iii) you are registered as an Event Listener at that object and cleared the reference when “disposing” is called.

An owner of an object calls method dispose to dispose of the object. Only the owner of the object calls method dispose if the object should be destroyed. All objects and components must release the references to the objects. If the object is a broadcaster, all listeners are removed and method XEventListener:: disposing ( ) is called on all listeners.

Due to the importance of the concept of method XComponent:: dispose ( ), a figurative example is provided. Imagine there was a hole in the floor and some people around it were holding a box (our component). Everyone who holds the box for a longer time than just temporarily (i.e. to put something in or get something out) has to watch a light bulb, which is attached to the box (listening to event XEventListener:: disposing ( )). Now, when the owner of the box switched the light on (calling method XComponent:: dispose ( )), everybody holding the box had to take their hands off (clear the interface handles). If and only if everyone did that, did the box fall (getting deleted). However, only the owner is allowed to switch the light on! After method dispose is called, the instance has to throw exception DisposedException for all non-event-method calls and event-method calls have to be ignored.

The following is an example of one embodiment.

void dispose ( )

{

/ / make a copy

Listener [ ] aTmpListeners=MyListeners.clone ( );

/ / clear all listeners (against recursion)

MyListeners.clear ( );

/ / call all listeners

EventObject aEvt=new EventObject ( );

aEvt.×Source=this;

for (i=0; i &amp;lt;aTmpListeners.length; i++)

aTmpListeners[i].disposing (aEvt);

}

Method addEventListener adds an event listener to the listener list for the object. The broadcaster fires the disposing method of this listener if method dispose ( ) is called. Conversely, method removeEventListener removes an event listener from the listener list for the object.

As described above, interface XComponent uses interface XEventListener (Table 17.)

TABLE 17
INTERFACE XEventListener

```
interface XEventListener:
    com: :sun: :star: :uno: :XInterface
{
void disposing( [in] com: :sun: :star: :lang: :EventObject
    Source ) ;
};
```

Interface XEventListener (Table 17) inherits from interface XInterface (Table 2). Interface XEventListener is a tagging interface that all event listener interfaces must extend. Method disposing is called when the broadcaster is about to be disposed. All listeners and all other objects, which reference the broadcaster should release the references. One embodiment of structure EventObject is presented in Table 18.

TABLE 18
Structure EventObject

struct EventObject
{
com: :sun: :star: :uno: :XInterface Source;
};

Structure EventObject specifies the base for all event objects and identifies the source of the event. Field Source refers to the object that fired the event.

As explained above, interface XWindow (Table 19) is used by interface XFrame (Table 15). See also FIG. 8A. In the embodiment of Table 19, interface XWindow inherits from interface XComponent (Table 16) and uses interfaces XWindowListener (Table 21), XFocusListener (Table 23), XKeyListener (Table 25), XMouseListener (Table 28), XMouseMotionListener (Table 30), and XPaintListener (Table 31), and structure Rectangle (Table 20), each of which is described herein.

TABLE 19
INTERFACE XWindow

```
interface XWindow: com: :sun: :star: :lang: :XComponent
{
[oneway] void setPosSize( [in] long X, [in] long Y,
    [in] long Width, [in] long Height, [in] short
    Flags ) ;
[const] com: :sun: :star: :awt: :Rectangle getPosSize() ;
[oneway] void setVisible ( [in] boolean Visible ) ;
[oneway] void setEnable ( [in] boolean Enable ) ;
[oneway] void setFocus() ;
[oneway] void addWindowListener( [in]
    com: :sun: :star: :awt: :XWindowListener xListener ) ;
[oneway] void removeWindowListener( [in]
    com: :sun: :star: :awt: :XWindowListener xListener ) ;
[oneway] void addFocusListener( [in]
    com: :sun: :star: :awt: :XFocusListener xListener ) ;
[oneway] void removeFocusListener( [in]
    com: :sun: :star: :awt: :XFocusListener xListener ) ;
[oneway] void addKeyListener( [in]
    com: :sun: :star: :awt: :XKeyListener xListener ) ;
[oneway] void removeKeyListener( [in]
    com: :sun: :star: :awt: :XKeyListener xListener ) ;
[oneway] void addMouseListener( [in]
    com: :sun: :star: :awt: :XMouseListener xListener ) ;
[oneway] void removeMouseListener( [in]
    com: :sun: :star: :awt: :XMouseListener xListener ) ;
[oneway] void addMouseMotionListener( [in]
    com: :sun: :star: :awt: :XMouseMotionListener
    xListener ) ;
[oneway] void removeMouseMotionListener( [in]
    com: :sun: :star: :awt: :XMouseMotionListener
    xListener ) ;
[oneway] void addPaintListener( [in]
    com: :sun: :star: :awt: :XPaintListener xListener ) ;
[oneway] void removePaintListener( [in]
    com: :sun: :star: :awt: :XPaintListener xListener ) ;
};
```

Interface XWindow (Table 19) specifies the basic operations for a window component. A window is a rectangular region on an output device with a position, size, and internal coordinate system. The main sense of a window is to receive events from the user.

Method setPosSize sets the outer bounds of the window. Method getPosSize returns the outer bounds of the window. Method setVisible shows or hides the window depending on the parameter. Method setEnable enables or disables the window depending on the parameter. Method setFocus sets the focus to the window. Method addWindowListener adds the specified component listener to receive component events from this window component. Method removeWindowListener removes the specified listener so it no longer receives component events from this window component. Method addFocusListener adds the specified focus listener to receive focus events from this window component. Method removeFocusListener removes the specified focus listener so it no longer receives focus events from this component. Method addKeyListener adds the specified key listener to receive key events from this component. Method removeKeyListener removes the specified key listener so it no longer receives key events from this component. Method addMouseListener adds the specified mouse listener to receive mouse events from this component. Method removeMouseListener removes the specified mouse listener so it no longer receives mouse events from this component. Method addMouseMotionListener adds the specified mouse motion listener to receive mouse motion events from this component. Method removeMouseMotionListener removes the specified mouse motion listener so it no longer receives mouse motion events from this component. Method addPaintListener adds the specified paint listener to receive paint events from this component. Method removePaintListener removes the specified paint listener so it no longer receives paint events from this component.

Structure Rectangle (Table 20) specifies a rectangular area by position and size. Field Y specifies the y-coordinate. Field Width specifies the width. Field Height specifies the height.

TABLE 20
STRUCTURE Rectangle

struct Rectangle
{
long X;
long Y;
long Width;
long Height;
};

An embodiment of interface XWindowListener that is used in the above embodiment of interface XWindow (Table 19) is presented in Table 21. Interface XWindowListener inherits from interface XEventListener (Table 17) and uses structure WindowEvent (Table 22.)

TABLE 21
INTERFACE XWindowListener

```
interface XWindowListener:
    com: :sun: :star: :lang: :XEventListener
{
[oneway] void windowResized( [in]
    com: :sun: :star: :awt: :WindowEvent e ) ;
[oneway] void windowMoved( [in]
    com: :sun: :star: :awt: :WindowEvent e ) ;
[oneway] void windowShown( [in]
    com: :sun: :star: :lang: :EventObject e ) ;
[oneway] void windowHidden( [in]
    com: :sun: :star: :lang: :EventObject e ) ;
};
```

Interface XWindowListener makes it possible to receive window events. Component events are provided only for notification purposes. Moves and resizes are handled internally by the window component, so that the GUI layout works properly independent of whether a program registers such a listener. Method windowResized is invoked when the window has been resized. Method windowMoved is invoked when the window has been moved. Method windowShown is invoked when the window has been shown. Method windowHidden is invoked when the window has been hidden.

One embodiment of structure WindowEvent used in Table 21 is presented in Table 22.

TABLE 22
STRUCTURE WindowEvent

struct WindowEvent: com: :sun: :star: :lang: :EventObject
{
long X;
long Y;
long Width;
long Height;
long LeftInset;
long TopInset;
long RightInset;
long BottomInset;
};

Structure WindowEvent specifies the component-level keyboard event and inherits from structure EventObject (Table 18). Field X specifies the outer X-position of the window. Field Y specifies the outer Y-position of the window. Field Width specifies the outer (total) width of the window. Field Height specifies the outer (total) height of the window. Field LeftInset specifies the inset from the left. The inset is the distance between the outer and the inner window, in other words in this case it is the width of the left border. Field TopInset specifies the inset from the top. The inset is the distance between the outer and the inner window, in other words in this case it is the height of the top border. Field RightInset specifies the inset from the right. The inset is the distance between the outer and the inner window, in other words in this case it is the width of the right border. Field BottomInset specifies the inset from the bottom. The inset is the distance between the outer and the inner window, in other words in this case it is the height of the bottom border.

An embodiment of interface XFocusListener that is used in the above embodiment of interface XWindow (Table 19) is presented in Table 23. Interface XFocusListener inherits from interface XEventListener (Table 17) and uses structure FocusEvent (Table 24.)

TABLE 23
INTERFACE XFocusListener

```
interface XFocusListener:
    com: :sun: :star: :lang: :XEventListener
{
[oneway] void focusGained( [in]
    com: :sun: :star: :awt: :FocusEvent e ) ;
[oneway] void focusLost( [in]
    com: :sun: :star: :awt: :FocusEvent e ) ;
};
```

Interface XFocusListener makes it possible to receive keyboard focus events. The window, which has the keyboard focus, is the window, which gets the keyboard events. Method focusGained is invoked when a window gains the keyboard focus. Method focusLost is invoked when a window loses the keyboard focus.

One embodiment of structure FocusEvent used in Table 23 is presented in Table 24.

TABLE 24
STRUCTURE FocusEvent

struct FocusEvent: com: :sun: :star: :lang: :EventObject
{
short FocusFlags;
com: :sun: :star: :uno: :XInterface NextFocus;
boolean Temporary;
};

Structure FocusEvent specifies a keyboard focus event, and inherits from structure EventObject (Table 18). There are two levels of focus change events: permanent and temporary. Permanent focus change events occur when focus is directly moved from one component to another, such as through calls to method requestFocus ( ) or as the user uses the Tab key to traverse components. Temporary focus change events occur when focus is gained or lost for a component as the indirect result of another operation, such as window deactivation or a scrollbar drag. In this case, the original focus state is automatically restored once that operation is finished, or for the case of window deactivation, when the window is reactivated. Both permanent and temporary focus events are delivered using the FOCUS_GAINED and FOCUS_LOST event ids; the levels may be distinguished in the event using the method isTemporary ( )

Field FocusFlags specifies the reason for the focus change as an arithmetic, or combination of FocusChangeReason. Field NextFocus contains the window which gets the focus on a lose focus event. Field Temporary specifies if this focus change event is a temporary change.

An embodiment of interface XKeyListener that is used in the above embodiment of interface XWindow (Table 19) is presented in Table 25. Interface XKeyListener inherits from interface XEventListener (Table 17) and uses structure KeyEvent (Table 24.) that in turn inherits from structure InputEvent (Table 27).

TABLE 25
INTERFACE XKeyListener

```
interface XKeyListener:
    com: :sun: :star: :lang: :XEventListener
{
[oneway] void keyPressed( [in]
    com: :sun: :star: :awt: :KeyEvent e ) ;
[oneway] void keyReleased( [in]
    com: :sun: :star: :awt: :KeyEvent e ) ;
};
```

Interface XKeyListener makes it possible to receive keyboard events. Method keypressed is invoked when a key has been pressed. Method keyReleased is invoked when a key has been released.

The embodiment of structure KeyEvent in Table 26 inherits from structure InputEvent (Table 27), as described above. Structure KeyEvent specifies the component-level keyboard event. Field KeyCode contains the integer code representing the key of the event. This is a constant from the constant group Key. Field KeyChar contains the Unicode character generated by this event or 0. Field KeyFunc contains the function type of the key event. This is a constant from the constant group KeyFunction.

TABLE 26
STRUCTURE KeyEvent

struct KeyEvent: com: :sun: :star: :awt: :InputEvent
{
short KeyCode;
char KeyChar;
short KeyFunc;
};

Structure InputEvent is the root event class for all component-level input events and inherits from structure EventObject (Table 18). Input events are delivered to listeners before they are processed normally by the source where they originated. Structure InputEvent contains the modifier keys, which were pressed while the event occurred, i.e., zero or more constants from the KeyModifier group.

TABLE 27
STRUCTURE InputEvent

struct InputEvent: com: :sun: :star: :lang: :EventObject
{
short Modifiers;
};

An embodiment of interface XMouseListener that is used in the above embodiment of interface XWindow (Table 19) is presented in Table 28. Interface XMouseListener inherits from interface XEventListener (Table 17) and uses structure MouseEvent (Table 29.) that in turn inherits from structure InputEvent (Table 27).

TABLE 28
INTERFACE XMouseListener

```
{
[oneway] void mousePressed( [in]
    com: :sun: :star: :awt: :MouseEvent e ) ;
[oneway] void mouseReleased( [in]
    com: :sun: :star: :awt: :MouseEvent e ) ;
[oneway] void mouseEntered( [in]
    com: :sun: :star: :awt: :MouseEvent e ) ;
[oneway] void mouseExited( [in]
    com: :sun: :star: :awt: :MouseEvent e ) ;
};
```

Interface XMouseListener makes it possible to receive events from the mouse in a certain window. Method mousePressed is invoked when a mouse button has been pressed on a window. Method mousereleased is invoked when a mouse button has been released on a window. Method mouseEntered is invoked when the mouse enters a window. Method mouseExited is invoked when the mouse exits a window.

The embodiment of structure MouseEvent in Table 29 inherits from structure InputEvent (Table 27).

TABLE 29
STRUCTURE MouseEvent

struct MouseEvent: com: :sun: :star: :awt: :InputEvent
{
short Buttons;
long X;
long Y;
long ClickCount;
boolean PopupTrigger;
};

Structure MouseEvent specifies an event from the mouse. Field Buttons contains the pressed mouse buttons, which are zero or more constants from the group MouseButton. Field X contains the x coordinate location of the mouse. Field Y contains the y coordinate location of the mouse. Field ClickCount contains the number of mouse clicks associated with event. Field PopupTrigger specifies if this event is a popup-menu trigger event.

An embodiment of interface XMouseMotionListener that is used in the above embodiment of interface XWindow (Table 19) is presented in Table 30. Interface XMouseMotionListener inherits from interface XEventListener (Table 17) and uses structure MouseEvent (Table 29).

TABLE 30
INTERFACE XMouseMotionListener

```
interface XMouseMotionListener:
    com: :sun: :star: :lang: :XEventListener
{
void mouseDragged( [in] com: :sun: :star: :awt: :MouseEvent
    e ) ;
void mouseMoved( [in] com: :sun: :star: :awt: :MouseEvent e ) ;
};
```

Interface XMouseMotionListener makes it possible to receive mouse motion events on a window. Method mouseDragged is invoked when a mouse button is pressed on a window and then dragged. Mouse drag events continue to be delivered to the window where the first event originated until the mouse button is released independent of whether the mouse position is within the bounds of the window. Method MouseMoved is invoked when the mouse button has been moved on a window with no buttons down.

An embodiment of interface XPaintListener that is used in the above embodiment of interface XWindow (Table 19) is presented in Table 31. Interface XPaintListener inherits from interface XEventListener (Table 17) and uses structure PaintEvent (Table 32) that inherits from structure EventObject (Table 18) and structure Rectangle (Table 20). See FIG. 8B.

TABLE 31
INTERFACE XPaintListener

```
interface XPaintListener:
    com: :sun: :star: :lang: :XEventListener
{
[oneway] void windowPaint( [in]
    com: :sun: :star: :awt: :PaintEvent e ) ;
};
```

Interface XPaintListener makes it possible to receive paint events. Method WindowPaint is called when a region of the window becomes invalid, for example, because another window was moved away.

TABLE 32
STRUCTURE PaintEvent

struct PaintEvent: com: :sun: :star: :lang: :EventObject
{
com: :sun: :star: :awt: :Rectangle UpdateRect;
short Count;
};

Structure PaintEvent specifies the paint event for a component. This event is a special type, which is used to ensure that paint/update method calls are serialized along with the other events delivered from the event queue. Field UpdateRect contains the rectangle area, which needs to be repainted. Field Count contains the number of paint events that follows this event if it is a multiple PaintEvent. Paint events can be collected until Count is zero.

An embodiment of interface XFramesSupplier that is used in the above embodiment of interface XWindow (Table 19) is presented in Table 33. Interface XFramesSupplier inherits from interface XFrame (Table 15) and uses interface XFrames that in turn inherits from several other interfaces as illustrated in FIG. 8B, and uses several structures, enumerations, and exceptions. One embodiment of each of these interfaces, structures, enumeration, and exceptions are described herein.

TABLE 33
INTERFACE XFramesSupplier

interface XFramesSupplier: XFrame
{
XFrames getFrames() ;
[const] XFrame getActiveFrame() ;
void setActiveFrame( [in XFrame xFrame ) ;
};

Method getFrames returns the collection of (sub-) frames, which is represented by a container FramesContainer. Method getActiveFrame returns the sub-frame, which is active within this frame. This may be the frame itself. The active frame is defined as the frame, which contains (recursively) the window with the focus. If no window within the frame contains the focus, this method returns the last frame, which had the focus. If no containing window ever had the focus, the first frame within this frame is returned.

Method setActive Frame is called on activation of a direct sub-frame. This method is allowed to be called only by a sub-frame. After this call, the frame specified by input parameter xFrame is returned. In general this method first calls the method at the creator frame with this as the current argument. Then it broadcasts the FrameActionEvent FrameAction:: FRAME_ACTIVATED.

In the embodiment of Table 34, interface XFrames inherits from interface XIndexAccess (Table 35). Interface XFrames manages and creates frames. Frames may contain other frames by implementing an interface XFrames and may be contained in other frames.

TABLE 34
INTERFACE XFrames

```
interface XFrames:
    com: :sun: :star: :container: :XIndexAccess
{
void append(
    [in] com: :sun: :star: :frame: :XFrame xFrame ) ;
sequence<com: :sun: :star: :frame: :XFrame> queryFrames(
    [in] long nSearchFlags ) ;
void remove( [in] com: :sun: :star: :frame: :XFrame xFrame
    ) ;
};
```

Method append appends the specified Frame to a list of sub-frames. Method queryFrames returns all child frames of the container, which are intended to be visible to other objects. The content of the sequence may be limited by the caller through the flag FrameSearchFlag.

Method remove removes the frame from its container. The creator attribute of the frame must be reset by the caller of this method.

The embodiment of interface XIndexAccess in Table 35 provides access to the elements of a collection through an index. This interface should only be used if the data structure itself is indexed.

TABLE 35
INTERFACE XIndexAccess

```
interface XIndexAccess:
    com: :sun: :star: :container: :XElementAccess
{
[const] long getCount() ;
[const] any getByIndex( [in] long Index )
    raises(
    com: :sun: :star: :lang: :IndexOutOfBoundsException,
    com: :sun: :star: :lang: :WrappedTargetException ) ;
};
```

Method getCount returns the number of elements. Method getByIndex returns the element at the specified index. Parameter Index specifies the position in the array. The first index is 0. Method getByIndex throws com:: sun:: star:: lang:: IndexOutOfBoundsException (Table 52) if the index is not valid. Method getByIndex throws com:: sun:: star:: lang:: WrappedTargetException (Table 49), if the implementation has internal reasons for exceptions that are wrapped in exception WrappedTargetException.

In this embodiment, interface XElementAccess is the base interface of all collection interfaces.

TABLE 36
INTERFACE XElementAccess

interface XElementAccess:
com: :sun: :star: :uno: :XInterface
{
[const] TYPE_XIDLCLASS getElementType() ;
[const] boolean hasElements() ;
};

Interface XElementAccess inherits from interface XInterface (Table 2). Method getElementType returns the type of the elements. Void means that the container is a multi-type container and the exact types with this interface cannot be determined with this method. Method hasElements returns <TRUE> if the object contain elements, otherwise <FALSE>.

One embodiment of interface XIdlClass is presented in Table 37. Interface XIdlClass provides information about a type or module. Every array also belongs to a type that is reflected as an XIdlClass object that is shared by all arrays with the same element type and number of dimensions. Finally, any of the primitive IDL types are also represented as XIdlClass objects. This includes “void, any, boolean, char, float, double, octet, short, long, hyper, unsigned octet, unsigned short, unsigned long” and “unsigned hyper”. Interface XIdlClass inherits from interface XInterface (Table 2)

TABLE 37
INTERFACE XIdlClass

interface XIdlClass: com: :sun: :star: :uno: :XInterface
{
sequence<XIdlClass> getClasses() ;
XIdlClass getClass ( [in] string aName ) ;
boolean equals( [in] XIdlClass Type ) ;
boolean isAssignableFrom( [in] XIdlClass xType ) ;
com: :sun: :star: :uno: :TypeClass getTypeClass() ;
string getName() ;
[const] com: :sun: :star: :uno: :Uik getUik() ;
sequence<XIdlClass> getSuperclasses () ;
sequence<XIdlClass> getInterfaces () ;
XIdlClass getComponentType() ;
XIdlField getField( [in] string aName ) ;
sequence<XIdlField> getFields() ;
XIdlMethod getMethod( [in] string aName ) ;
sequence<XIdlMethod> getMethods() ;
XIdlArray getArray() ;
void createObject( [out] any obj ) ;
};

Method getClasses returns all types and modules, which are declared in this class. Method getClass returns a type or module with the given name that is declared in this class. Method equals returns <TRUE> if the instances describe the same type, otherwise <FALSE>. Method isAssignableFrom tests if the parameter xType is a subclass of this class. Method getTypeClass returns the type that this instance represents. Method getName returns the fully qualified name of the type of object (class, interface, array, sequence, struct, union, enum or primitive) represented by this XIdlClass object. Method getUik returns the UIK from this type. If the type has no UIK, the returned UIK is zero.

If this object represents an interface or a class, the objects that represent the superclasses or superinterfaces of that class are returned by method getSuperclasses. If this object is the one that represents the topmost class or interface, an empty sequence is returned.

Method getInterfaces determines the interfaces implemented by the class or interface represented by this object. If the class or interface implements no interfaces, the method returns a sequence of length 0.

If this class represents an array or sequence type, method GetComponentType returns the XIdlClass object representing the component type of the array or sequence; otherwise it returns null. Method getField returns an XIdlField object that reflects the specified member field of the class, interface, struct, union, enum or exception represented by this XIdlClass object. If a field with the specified name is not found, 0 is returned. The field to be reflected is located by searching all the member fields of the class, interface, struct, union, enum or exception represented by this XIdlClass object for a field with the specified name or for NULL, if a field with the specified name is not found. Parameter aName specifies the simple name of the desired field.

Method getFields returns a sequence containing Field objects reflecting all the accessible fields of the class, interface, struct, union or enum represented by this XIdlClass object. Method getFields returns a sequence of length 0 if the class or interface has no accessible fields, or if it represents an array, a sequence or a primitive type. Specifically, if this XIdlClass object represents a class, this method returns the fields of this class and of all its superclasses. If this XIdlClass object represents an interface, the method returns the fields of this interface and of all its superinterfaces. If this XIdlClass object represents an array, sequence or primitive type, this method returns a sequence of length 0.

Method getMethod returns an XIdlMethod object that reflects the specified member method of the interface represented by this XIdlClass object. If a method with the specified name is not found, “0” is returned. The method to be reflected is located by searching all the member methods of the interface represented by this XIdlClass object for a method with the specified name. Parameter aName specifies the simple name of the desired method.

Method getMethods returns a sequence containing XIdlMethod objects reflecting all the member methods of the class or interface represented by this XIdlClass object, including those declared by the class or interface and those inherited from superclasses and superinterfaces. Returns a sequence of length 0 if the class or interface has no member methods.

Method getArray returns interface XldlArray (Table 50) to get and set the elements by index if the represented type is an array or sequence. Method createObject creates an instance of the type represented by this XIdlClass object if the represented type is a basic type, struct, enum, or sequence.

Enumeration TypeClass (Table 38) describe all type classes, which can be defined in the IDL.

TABLE 38
Enumeration TypeClass

enum TypeClass
{
VOID,
CHAR,
BOOLEAN,
BYTE,
SHORT,
UNSIGNED_SHORT,
LONG,
UNSIGNED_LONG,
HYPER,
UNSIGNED_HYPER,
FLOAT,
DOUBLE,
STRING,
TYPE,
ANY,
ENUM,
TYPEDEF,
STRUCT,
UNION,
ARRAY,
INTERFACE,
SERVICE,
MODULE,
INTERFACE_METHOD,
INTERFACE_ATTRIBUTE,
UNKNOWN
};

Interface XIdlField (Table 39) inherits from interface XIdlMember (Table 40).

TABLE 39
INTERFACE XIdlField

```
interface XIdlField:
    com: :sun: :star: :reflection: :XIdlMember
{
com: :sun: :star: :reflection: :XIdlClass getType() ;
com: :sun: :star: :reflection: :FieldAccessMode
    getAccessMode() ;
any get( [in] any obj )
  raises(
    com: :sun: :star: :lang: :IllegalArgumentException ) ;
void set( [in] any obj, [in] any value )
  raises(
    com: :sun: :star: :lang: :IllegalArgumentException,
    com: :sun: :star: :lang: :IllegalAccessException ) ;
};
```

Method getType returns an XIdlClass object that identifies the declared type for the field represented by this XIdlField object. Method getAccessMode returns an enumeration value, which denotes whether the field is “const”, “readonly”, “writeonly”or “readwrite”.

Method get returns the value of the field represented by this field on the specified object. The underlying field's value is obtained as follows:

If the underlying field is a constant, the object argument is ignored; it may be NULL;

Otherwise, the underlying field is an instance field.

If the specified object argument is NULL, the method throws an “IllegalArgumentException”. If the specified object is not an instance of the class, interface, struct, union or enum declaring the underlying field, the method throws an “IllegalArgumentException”. Otherwise, the value is retrieved from the underlying instance or constant.

Method set sets the field represented by this XIdlField object on the specified object argument to the specified new value. The operation proceeds as follows. If the specified object argument is NULL, the method throws an exception IllegalArgumentException (Table 42). If the specified object argument is not an instance of the class or interface declaring the underlying field, the method throws an exception IllegalArgumentException. If the underlying field is constant, the method throws an exception IllegalAccessException (Table 43). If the new value cannot be converted to the type of underlying field by an identity or widening conversion, the method throws an IllegalArgumentException. The field is set to the possibly widened new value.

Interface XIdlMember (Table 40) inherits from interface XInterface (Table 2). Interface XIdlMember makes it possible to access members of classes dynamically.

TABLE 40
INTERFACE XIdlMember

interface XIdlMember: com: :sun: :star: :uno: :XInterface
{
XIdlClass getDeclaringClass() ;
string getName() ;
};

Method getDeclaringClass returns the XIdlClass object representing the class, interface, struct, union or enum that declares the member represented by this member. Method getName returns the fully qualified name of the type (class, interface, array, sequence, struct, union, enum or primitive) represented by this XIdlClass object, as a string.

The values in enumeration FieldAccessMode (Table 41) are used to specify the kind of attribute or property.

TABLE 41
Enumeration FieldAccessMode

```
enum FieldAccessMode
{
//--------------------------------------------------
/** The property is readable and writeable
  */
    READWRITE,
//--------------------------------------------------
/** The property is readonly
  */
READONLY,
//--------------------------------------------------
/** The property is write only
  */
WRITEONLY,
//--------------------------------------------------
/** @deprecated
  */
CONST
};
```

Exception IllegalArgumentException (Table 42) is thrown to indicate that a method has passed an illegal or inappropriate argument. Exception IllegalArgumentException inherits from exception Exception (Table 12). Field ArgumentPosition identifies the position of the illegal argument. This field is −1 if the position is not known.

TABLE 42
EXCEPTION IllegalArgumentException

exception IllegalArgumentException:
com: :sun: :star: :uno: :Exception
{
short ArgumentPosition;
};

Exception IllegalAccessException (Table 43) is thrown when an application tries to change a constant property. Exception IllegalAccessException inherits from exception Exception (Table 12).

TABLE 43
EXCEPTION IllegalAccessException

exception IllegalAccessException:
com: :sun: :star: :uno: :Exception
{
};

Interface XIdlMethod (Table 44) inherits from interface XIdlMember (Table 40). Interface XIdlMember makes it possible to access the specification of a method dynamically.

TABLE 44
INTERFACE XIdlMethod

```
interface XIdlMethod:
    com: :sun: :star: :reflection: :XIdlMember
{
XIdlClass getReturnType() ;
sequence<XIdlClass> getparameterTypes() ;
sequence<ParamInfo> getParameterInfos() ;
sequence<com: :sun: :star: :reflection: :XIdlClass>
    getExceptionTypes() ;
com: :sun: :star: :reflection: :MethodMode getMode() ;
any invoke( [in] any obj, [inout] sequence<any> args )
  raises(
    com: :sun: :star: : lang: : IllegalArgumentException,
  com: :sun: :star: :reflection: :InvocationTargetException
    ) :
};
```

Method getReturnType returns an XIdlClass object that represents the formal return type of the method represented by this method object. Method getParameterTypes returns a sequence of XIdlClass objects that represent the formal parameter types, in declaration order, of the method represented by this Method object. Method getParameterTypes returns a sequence of length 0 if the underlying method takes no parameters.

Method getParameterInfos returns a sequence of ParamInfo objects that represent all information about the formal parameter types, in declaration order, of the method represented by this Method object. Method getParameterInfos returns a sequence of length 0 if the underlying method takes no parameters.

Method getExceptionTypes returns a sequence of XIdlClass objects that represent the types of the checked exceptions thrown by the underlying method represented by this Method object. Method getExceptionTypes returns a sequence of length 0 if the method throws no checked exceptions.

Method getMode returns an enumeration value, which denotes whether the method is one-way or two-way. Method invoke invokes the underlying method represented by this method object on the specified object with the specified parameters. Individual parameters are subject to widening conversions as necessary.

Method invocation proceeds in the following order:

If the specified object argument is NULL, the invocation throws an IllegalArgumentException; and

Otherwise, if the specified object argument is not an instance of the class or interface declaring the underlying method, the invocation throws an exception IllegalArgumentException (Table 42).

If the number of actual parameters supplied via args is different from the number of formal parameters required by the underlying method, the invocation throws an Exception IllegalArgumentException. For each actual parameter in the supplied args array, if the parameter value cannot be converted to the corresponding formal parameter type by an identity or widening conversion, the invocation throws exception IllegalArgumentException. When the control transfers to the underlying method and the method stops abruptly by throwing an exception, the exception is placed in an exception InvocationTargetException (Table 48) and thrown in turn to the caller of the method. If the method completes normally, the value it returns is returned to the caller of the method. If the underlying method returns type is void, the invocation returns VOID.

Structure ParamInfo (Table 45) describes a formal parameter of a method.

TABLE 45
STRUCTURE ParamInfo

struct ParamInfo
{
/ ** The name of the parameter.
*/
string aName;
//-----------------------------------------------------------
/** One of the values IN, OUT, INOUT from the ParamMode
enumeration.
*/
ParamMode aMode;
//-----------------------------------------------------------
/** The type of the parameter.
*/
XIdlClass aType;
};

The values in Enumeration ParamMode (Table 46) are used to specify if a formal parameter of a method is used for input, output or both. If the value is an IN parameter, data can only transferred from the callee to the caller. If the value is an OUT parameter, data can only transferred from the caller to the callee. If value is an INOUT parameter, data can transferred in both directions.

TABLE 46
ENUMERATION ParamMode

enum ParamMode
{
IN,
OUT,
INOUT
};

The values in Enumeration MethodMode (Table 47) are used to specify the calling mode of a method. If the value is an ONEWAY parameter, the method call may be asynchronous. If the value is a TWOWAY parameter, the method call is synchronous.

TABLE 47
ENUMERATION MethodMode

enum MethodMode
{
ONEWAY
TWOWAY
};

Exception InvocationTargetException (Table 48) is a checked exception that wraps another exception. Typically such exceptions are thrown by an invoked method or constructor. Exception InvocationTargetException inherits from exception WrappedTargetException (Table 49).

TABLE 48
EXCEPTION InvocationTargetException

exception InvocationTargetException:
com: :sun: :star: :lang: :WrappedTargetException
{
};

Exception WrappedTargetException (Table 49) is a checked exception that wraps an exception thrown by the original target. Normally this exception is declared for generic methods. Exception WrappedTargetException inherits from exception Exception(Table 12).

TABLE 49
EXCEPTION WrappedTargetException

exception WrappedTargetException:
com: :sun: :star: :uno: :Exception
{
any TargetException;
};

Interface XldlArray (Table 50) provides methods to dynamically access arrays. Interface XldlArray inherits from interface XInterface (Table 2).

TABLE 50
INTERFACE XIdlArray

```
interface XIdlArray: com: :sun: :star: :uno: :XInterface
{
void realloc( [inout] any array, [in] long length )
  raises(
    com: :sun: :star: :lang: :IllegalArgumentException. ) ;
long getLen( [in] any array )
  raises(
    com: :sun: :star: :lang: :IllegalArgumentException );
any get( [in] any aArray, [in] long nIndex )
  raises(
    com: :sun: :star: :lang: :IllegalArgumentException,
    com: :sun: :star: :lang: :ArrayIndexOutOfBoundsExcepti
      on );
void set( [inout] any aArray, [in] long nIndex, [in]
    any aNewValue )
  raises(
    com: :sun: :star: :lang: : IllegalArgumentException,
  com: :sun: :star: :lang: :ArrayIndexOutOfBoundsException
    ) ;
};
```

Method realloc in interface XldlArray changes the size of the array to the new size. If the new length is greater, the additional elements are default constructed, otherwise the elements are destructed. Method realloc throws an exception IllegalArgumentException (Table 42) if the specified object is not an array or if the specified object is null.

Method getLen in interface XldlArray returns the number of elements in the array. Method getLen throws an exception IllegalArgumentException (Table 42) if the specified object is not an array or if the specified object is null.

Method get in interface XldlArray returns the value of the indexed component in the specified array object. Method get throws exception IllegalArgumentException, if the specified object is not an array or if the specified object is null. Method get throws exception ArrayIndexOutOfBoundsException (Table 51), if the specified index argument is negative, or if the specified index argument is greater than or equal to the length of the specified array.

Method set in interface XldlArray sets the value of the indexed component of the specified array object to the specified new value. Method set throws exception IllegalArgumentException, if the specified object is not an array or if the specified object is null. Method set throws exception ArrayIndexOutOfBoundsException (Table 51), if the specified index argument is negative, or if the specified index argument is greater than or equal to the length of the specified array.

Exception ArrayIndexOutOfBoundsException (Table 51) is thrown to indicate that an array has been accessed with an illegal index. The index is either negative or greater than or equal to the size of the array. Exception ArrayIndexOutOfBoundsException inherits from exception IndexOutOfBoundsException (Table 52).

TABLE 51
EXCEPTION ArrayIndexOutOfBoundsException

exception ArrayIndexOutOfBoundsException:
com::sun::star::lang::IndexOutOfBoundsException
{
};

Exception IndexOutOfBoundsException (Table 52) is thrown to indicate that a container has been accessed with an illegal index. The index is either negative or greater than or equal to the count of the elements. Exception IndexOutOfBoundsException inherits from exception Exception (Table 12).

TABLE 52
EXCEPTION IndexOutOfBoundsException

exception IndexOutOfBoundsException
com::sun::Star::uno::Exception
{
};

As explained above, interface XFrame (Table 15) uses interface XController (Table 53). With interface XController, components viewed in a frame can serve events by supplying dispatches. Interface XController inherits from interface XComponent (Table 16).

TABLE 53
INTERFACE XController

interface XController: com::sun::star::lang::XComponent
{
void attachFrame( [in] XFrame xFrame );
boolean attachModel ( [in] XModel xModel );
boolean suspend( [in] boolean bSuspend );
any getViewData();
void restoreViewData( [in] any Data );
XModel getModel();
XFrame getFrame();
};

Method attachFrame (Table 53) is called to attach the controller with its managing frame. Method attachModel is called to attach the controller to a new model. Method suspend is called to prepare the controller for closing the view. Method getViewData returns data that can be used to restore the current view status. Method restoreViewData restores the view status using the data gotten from a previous call. Method getModel returns the currently attached model. Method getFrame returns the frame containing this controller.

In Table 54, interface XModel represents a component, which is created from an URL and arguments. Interface XModel is a representation of a resource in the sense that the interface was created/loaded from the resource. The arguments are passed to the loader to modify its behavior. An example for such an argument is “AsTemplate”, which loads the resource as a template for a new document. Models can be controlled by controller components, which are usually views of the model. If there is at least one controller, there is by definition a current controller, and if that controller supports interface XSelectionSupplier, it has a current selection too. Interface XModel inherits from interface XComponent (Table 16).

TABLE 54
INTERFACE XModel

```
interface XModel: com::sun::star::lang::XComponent
{
boolean attachResource( [in] string aURL, [in]
  sequence<com::sun::star::beans::PropertyValue>
  aArgs );
string getURL();
sequence<com::sun::star::beans::PropertyValue>
  getArgs();
[oneway] void connectController( [in]
  com::sun::star::frame::XController xController );
[oneway] void disconnectController( [in]
  com::sun::star::frame::XController xController);
[oneway] void lockControllers();
[oneway] void unlockControllers();
boolean hasControllersLocked();
  [const] com::sun::star::frame::XController
  getCurrentController();
void setCurrentController( [in]
  com::sun::star::frame::XController xController)
  raises(
    com::sun::star::container::NoSuchElementExcep
    tion );
[const] com::sun::star::uno::XInterface
  getCurrentSelection();
};
```

Method attachResource (Table 54) informs a model about its resource description. Method getURL returns the URL of the resource, which is represented by this model. Method getArgs returns the arguments with which the model was originally created or stored the last time. Method connectController is called whenever a new controller is created for this model. Interface XComponent of the controller must be used to recognize when the controller is deleted. Method disconnectController is called whenever a new controller is created for this model. Again, interface XComponent of the controller must be used to recognize when the controller is deleted.

Method lockControllers (Table 54) suspends some notifications to the controllers, which are used for display updates. The calls to this method may be nested and even overlapping, but the calls must be in pairs. While there is at least one lock remaining, some notifications for display updates are not broadcasted.

Method unlockControllers (Table 54) resumes the notifications, which were suspended by call to lockControllers. The calls to this method may be nested and even overlapping, but they must be in pairs. While there is at least one lock remaining, some notifications for display updates are not broadcasted.

Method hasControllersLocked (Table 54) determines if there is at least one lock remaining. While there is at least one lock remaining, some notifications for display updates are not broadcasted to the controllers.

Method getCurrentController (Table 54) returns the controller, which currently controls this model. If the controller, which is active, is a controller of this model, it will be returned. If not, the controller, which was the last active controller of this model, is returned. If no controller of this model ever was active, the controller first registered is returned. If no controller is registered for this model, NULL is returned.

Method setCurrentController (Table 54) sets a registered controller as the current controller. Method setCurrentController throws exception NoSuchElementException (Table 58).

Method getCurrentSelection (Table 54) returns the current selection in the current controller. If there is no current controller, the method returns NULL.

Structure PropertyValue (Table 55) specifies a property value. Field Name (Table 55) specifies the name of the property. The name is unique within a sequence of PropertyValues. Field Handle (Table 55) contains an implementation-specific handle for the property. The handle may be −1 if the implementation has no handle. If available, the handle it can be used for fast lookups. Field Value contains the value of the property or void if no value is available. Field State determines if the value comes from the object itself or from a default, and if the value cannot be determined exactly

TABLE 55
STRUCTURE PropertyValue

struct PropertyValue
{
string Name;
long Handle;
any Value;
com:sun::star::beans::PropertyState State;
};

Enumeration PropertyState (Table 56) lists the states that a property value can have. The state consists of two aspects: whether a value is available or void; and whether the value is stored in the property set itself or is a default or ambiguous.

Value DIRECT_VALUE (Table 56) of the property is stored in the PropertySet itself. The property value must be available and of the specified type. If field PropertyAttribute in structure Property (Table 57) contains PropertyAttribute:: MAYBEVOID, then the value may be void.

Value DEFAULT_VALUE (Table 56) of the property is available from a master (e.g. template). Field PropertyAttribute in structure Property (Table 57) must contain the flag PropertyAttribute:: MAYBEDEFAULT. The property value must be available and of the specified type. If field PropertyAttribute in the structure Property contains PropertyAttribute:: MAYBEVOID, the value may be void.

Value AMBIGUOUS_VALUE (Table 56) of the property is only a recommendation because there are multiple values for this property (e.g. from a multi selection). Field PropertyAttribute in structure Property (Table 57) must contain flag PropertyAttribute:: MAYBEAMBIGUOUS. The property value must be available and of the specified type. If field Attribute in structure Property contains PropertyAttribute:: MAYBEVOID, n the value may be void.

TABLE 56
Enumeration PropertyState

enum PropertyState
{
DIRECT_VALUE,
DEFAULT_VALUE,
AMBIGUOUS_VALUE
};

Structure Property (Table 57) describes a property. There are three types of properties: bound properties, constrained properties and free properties. Field Name specifies the name of the property. The name is unique within an XPropertySet. Field Handle contains an implementation specific handle for the property. The handle may be −1 if the implementation has no handle. Field Type contains an object that identifies the declared type for the property. If the property has multiple types or the type is not known, but not any, void must be returned. Field Attributes may contain zero or more constants of the PropertyAttribute constants group.

TABLE 57
Structure Property

struct Property
{
string Name;
long Handle;
TYPE_XIDLCLASS Type;
short Attributes;
};

Exception NoSuchElementException (Table 58) is thrown by the method to indicate that there are no more elements in the enumeration. Exception NoSuchElementException inherits from exception Exception (Table 12).

TABLE 58
EXCEPTION NoSuchElementException

exception NoSuchElementException:
com::sun::star::uno::Exception
{
};

As explained above, interface XFrame (Table 15) uses interface XFrameActionListener (Table 59). Interface XFrameActionListener has to be provided if an object wants to receive events when several things happen to components within frames of the desktop, e.g., events of instantiation/destruction and activation/deactivation of components can be received.

Interface XFrameActionListener inherits from interface XEventListener (Table 17). Method frameAction is called whenever any action occurs to a component within a frame.

TABLE 59
INTERFACE XFrameActionListener

```
interface XFrameActionListener:
  com::sun::star::lang::XEventListener
{
[oneway] void frameAction( [in]
  com::sun::star::frame::FrameActionEvent aEvent );
};
```

Event structure FrameActionEvent (Table 60) is broadcast for action, which can happen to components within frames. Event structure FrameActionEvent inherits from structure EventObject (Table 18).

In Table 60, field Frame contains the frame in which the event occurred. Field Action specifies the concrete event.

TABLE 60
Structure FrameActionEvent

struct FrameActionEvent:
com::sun::star::lang::EventObject
{
com::sun::star::frame::XFrame Frame;
com::sun::star::frame::FrameAction Action;
};

Enumeration FrameAction (Table 61) specifies the events, which can happen to components in frames. An event COMPONENT_ATTACHED is broadcast whenever a component is attached to a frame. This is almost the same as the instantiation of the component within that frame. The component is attached to the frame immediately before this event is broadcast. An event COMPONENT_DETACHING is broadcast whenever a component is detaching from a frame. This is quite the same as the destruction of the component, which was in that frame. At the moment when the event is broadcast the component is still attached to the frame but in the next moment it is not attached. An event COMPONENT_REATTACHED is broadcast whenever a component is attached to a new model. In this case the component remains the same but operates on a new model component. An event FRAME_ACTIVATED is broadcast whenever a component is activated. Activations are broadcast from the top component, which was not active before, down to the inner most component. An event FRAME_DEACTIVATING broadcast immediately before the component is deactivated. Deactivations are broadcast from the innermost component, which does not stay active up to the outer most component, which does not stay active. An event CONTEXT_CHANGED is broadcast whenever a component changed its internal context (i.e. the selection). If the activation status within a frame changes, this counts as a context change too. An event FRAME_UI_ACTIVATED is broadcast by an active frame when the active frame is getting user interface control (tool control). An event FRAME_UI_DEACTIVATING is broadcast by an active frame when the active frame is losing user interface control (tool control).

TABLE 61
ENUMERATION FrameAction

enum FrameAction
{
COMPONENT_ATTACHED,
COMPONENT_DETACHING,
COMPONENT_REATTACHED,
FRAME_ACTIVATED,
FRAME_DEACTIVATING,
FRAME_UI_ACTIVATED,
FRAME_UI_DEACTIVATING
};

As described above, interface XDispatchProvider (Table 62 and FIG. 9) is an interface of class BeanFrame (FIG. 6). Interface XDispatchProvider provides Dispatch interfaces for certain functions, which are useful at the user interface. Interface XDispatchProvider inherits from interface XInterface (Table 2), and uses interface XDispatch (Table 63) and structures URL (Table 64) and DispatchDescriptor (Table 67).

TABLE 62
INTERFACE XDispatchProvider

interface XDispatchProvider:

com::sun::star::uno::XInterface

{
com::sun::star::frame::XDispatch queryDispatch( [in]

com::sun::star::util::URL aURL,

[in] string aTargetFrameName,
[in] long nSearchFlags );

sequence<com::sun::star::frame::XDispatch>

queryDispatches( [in]
sequence<com::sun::star::frame::DispatchDescriptor
> aDescripts );

};

Method queryDispatch (Table 62) searches for an XDispatch for the specified URL within the specified target frame. Method queryDispatches returns multiple dispatch interfaces for the specified descriptors at once. Actually this method is redundant to method DispatchProvider:: queryDispatch to avoid multiple remote calls.

Interface XDispatch (Table 63) serves state information of objects, which can be connected to controllers (e.g. toolbox controllers). Each state change is to be broadcast to all registered status listeners. The first notification should be performed synchronously, if not, controllers may flicker. State listener must be aware of this synchronous notification. The state includes enabled/disabled and a short descriptive text of the function (e.g. “undo insert character”). The state is to be broadcast whenever this state changes or the controller should reget the value for the URL to which it is connected. Additionally, a context-switch-event is to be broadcast whenever the object may be out of scope to force the state listener to requery the XDispatch. Interface XDispatch inherits from interface XInterface (Table 2).

TABLE 63
INTERFACE XDispatch

interface XDispatch: com::sun::star::uno::XInterface
{
[oneway] void dispatch( [in] com::sun::star::util::URL

aURL, [in]
sequence<com::sun::star::beans::PropertyValue>
aArgs );

[oneway] void addStatusListener( [in]

com::sun::star::frame::XStatusListener xControl,
[in] com::sun::star::util::URL aURL );

[oneway] void removeStatusListener( [in]

com::sun::star::frame::XStatusListener xControl,
[in] com::sun::star::util::URL aURL );

};

Method dispatch (Table 63) dispatches (executes) an URL asynchronously. Method dispatch is only allowed to dispatch URLs for which the current user gets the dispatch. Additional arguments “′# . . . ” or “? . . . ” are allowed.

The following is an example for a click-handler of a hyperlink in a view.

XFrame×TargetFrame=m_×Frame-&amp;gt;findFrame (m_aHyperlink-&amp;gt;getTargetFrameName( ), FRAME_SEARCH_STANDARD);

URL aURL;

aURL.Original=m_aHyperlink-&amp;gt;getURL( );

XDispatch m_xFrame-&amp;gt ;queryDispatch(aURL, sequence&amp; It; PropertyValue&amp;gt; ( ) );

xDispatch-&amp;gt;dispatch(aURL);

Method addStatusListener (Table 63 ) registers a listener of a controller for a specific URL to this object to receive status events. This method is only allowed to register for URLs for which the current user gets this dispatch. Additional arguments “# . . . ”or “? . . . ” are ignored. Method removeStatusListener unregisters a listener of a controller.

Structure URL (Table 64) represents the original and the parsed structure of a Uniform Resource Locator. It is not necessary to set all of the fields; either URL:: Complete or (some of) the others are set. Additionally, most of the other fields, like URL:: User, URL:: Password or URL:: Mark, are optional.

In Table 64, field Complete contains the unparsed original URL, for example, http:/ /me:pass@www.stardivision.de:8080/pub/test/foo.txt ?a=b#xyz. Field Main contains the URL without a mark and without arguments, for example. http:/ /me:pass@www.stardivision.de:8080/pub/test/foo.txt. Field Protocol contains the protocol (scheme) of the URL, for example, “http”. Field User contains the user-identifier of the URL, for example, “me”. Field Password contains the users password of the URL, for example, “pass”. Field Server contains the server part of the URL, for example, “www.stardivision.de”. Field Port contains the port at the server of the URL, for example, “8080”. Field Path contains the path part of the URL without the filename, for example, “/pub/test”. Field Name contains the filename part of the URL, for example, “foo.txt”. Field Arguments contains the arguments part of the URL, for example, “a=b”. Field Mark contains the mark part of the URL, for example “xyz”.

TABLE 64
STRUCTURE URL

struct URL
{
string Complete;
string Main;
string Protocol;
string User;
string Password;
string Server;
short Port;
string Path;
string Name;
string Arguments;
string Mark;
};

As explained above, interface XStatusListener (Table 65) is used by interface XDispatch (Table 63 and FIG. 9). Interface XStatusListener makes it possible to receive events when the state of a feature changes. Interface XStatusListener inherits from interface XEventListener (Table 17). Method statusChanged is called when the status of the feature changes.

TABLE 65
INTERFACE XStatusListener

interface XStatusListener:

com::sun::star::lang::XEventListener

{
[oneway] void statusChanged( [in]

com::sun::star::frame::FeatureStateEvent Event );

};

Structure FeatureStateEvent (Table 66) is broadcast by a controller, whenever the state of the feature changes. Structure FeatureStateEvent inherits from structure EventObject (Table 18).

In Table 66, field FeatureURL contains the URL of the feature. Field FeatureDescriptor contains a descriptor of the feature for the user interface. Field IsEnabled specifies whether the feature is currently enabled or disabled. Field Requery specifies whether the Dispatch has to be requeried. Field State contains the state of the feature in this dispatch. This can be, for example, simply TRUE for a Boolean feature like underline on/off. Some simple types like string or Boolean are useful here for generic user interface elements, like a checkmark in a menu.

TABLE 66
STRUCTURE FeatureStateEvent

struct FeatureStateEvent:

com::sun::star::lang::EventObject

{
com::sun::star::util::URL FeatureURL;
string FeatureDescriptor;
boolean IsEnabled;
boolean Requery;
any State;
};

Structure DispatchDescriptor (Table 67) describes a feature to be retrieved by an URL that has to be loaded into a specified frame. Field FeatureURL specifies the URL of the resource/function. Field FrameName is the name of the target frame. Field SearchFlags is how the target frame is to be searched.

TABLE 67
STRUCTURE DispatchDescriptor

struct DispatchDescriptor
{
com::sun::star::util::URL FeatureURL;
string FrameName;
long SearchFlags;
};

In the embodiment of FIG. 6, the component loaded is StarWriter, and class StarWriter includes interface XLoadable (Table 68 and FIG. 9). Interface XLoadable provides functionality to implement objects, which may be loaded. Interface XLoadable inherits from interface XInterface (Table 2).

TABLE 68
INTERFACE XLoadable

interface XLoadable: com::sun::star::uno::XInterface
{
[oneway] void load();
[oneway] void unload();
[oneway] void reload();
boolean isLoaded();
[oneway] void addLoadListener( [in]

com::sun::star::form::XLoadListener aListener );

[oneway] void removeLoadListener( [in]

com::sun::star::form::XLoadListener aListener );

};

Method load (Table 68) starts the data processing. Method unload stops the data processing. Method reload does a smart refresh of the object. The final state is the same as if unload and load were called, but reload is the more efficient way to do the same. If the object isn't loaded, nothing happens. Method isLoaded returns true if the object is in loaded state. Method addLoadListener adds the specified listener to receive events “loaded” and “unloaded.” Method removeLoadListener removes the specified listener.

Interface XLoadListener (Table 69) is used in the load listener method calls in Table 68. Interface XLoadListener receives “loaded” and “unloaded” events posted by a loadable object. The interface is typically implemented by data-bound components, which want to listen to the data source that contains their database form. Interface XLoadListener inherits from interface XEventListener (Table 17).

TABLE 69
INTERFACE XLoadListener

interface XLoadListener:

com::sun::star::lang::XEventListener

{
[oneway] void loaded( [in]

com::sun::star::lang::EventObject aEvent );

[oneway] void unloading( [in]

com::sun::star::lang::EventObject aEvent );

[oneway] void unloaded( [in]

com::sun::star::lang::EventObject aEvent );

[oneway] void reloading( [in]

com::sun::star::lang::EventObject aEvent );

[oneway] void reloaded( [in]

com::sun::star::lang::EventObject aEvent );

};

Method loaded (Table 69) is invoked when the object has successfully connected to a data source. Method unloading is invoked when the object is about to be unloaded. Components may use this to stop any other event processing related to the event source before the object is unloaded. Method unloaded is invoked after the object has disconnected from a data source. Method reloading is invoked when the object is about to be reloaded. Components may use this to stop any other event processing related to the event source until they get the reloaded event. Method reloaded is invoked when the object has been reloaded.

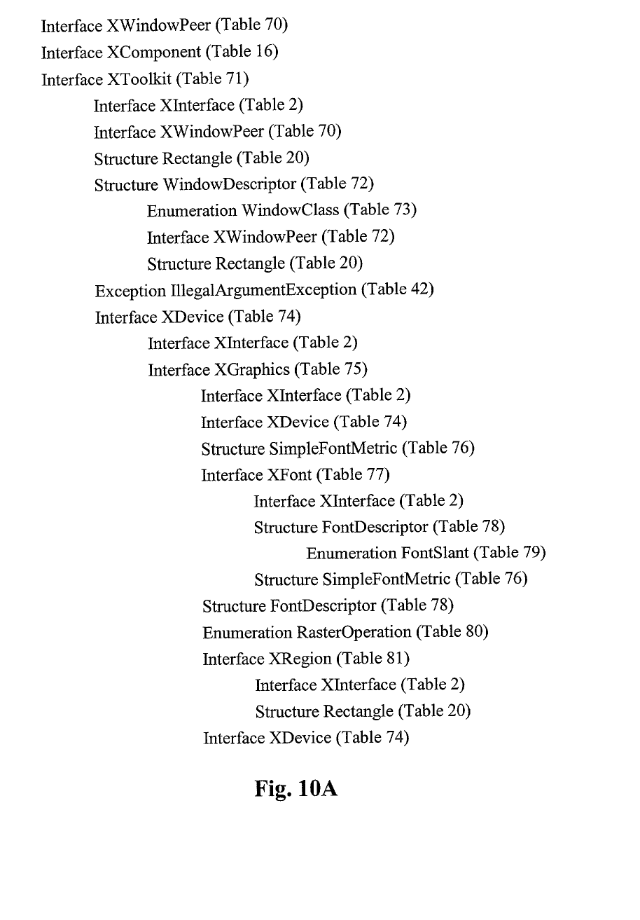

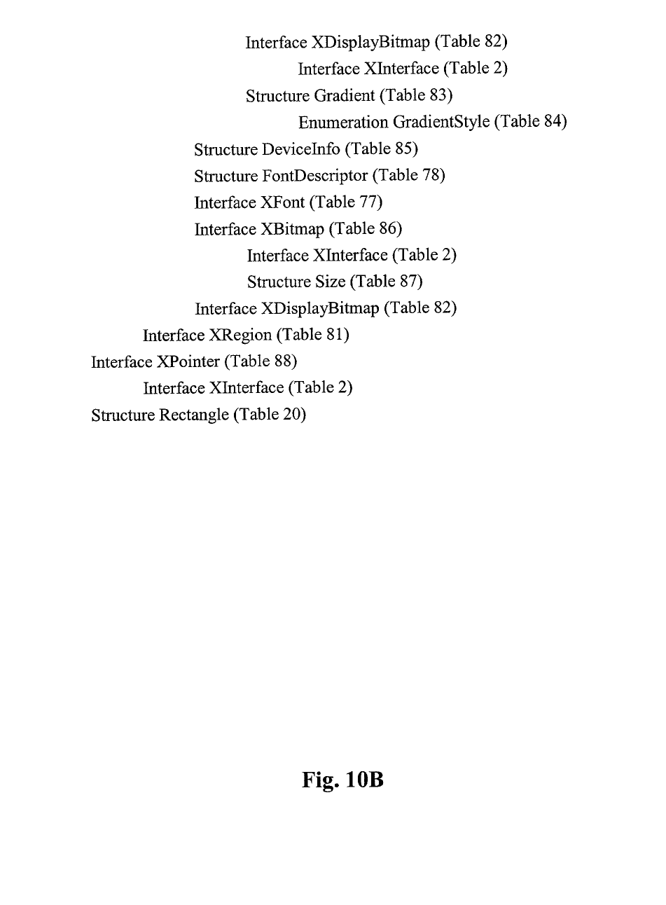

Class BeanWindow (FIG. 6) includes interfaces XWindowPeer (Table 70) and XEventHdl (Table 4). Interface XWindowpeer gives access to the actual window implementation on the device. Interface XWindowPeer inherits from interface XComponent (Table 16), and uses interfaces XToolKit (Table 71) and XPointer (Table 88), which are described below. See also FIGS. 10A and 10B.

TABLE 70
INTERFACE XWindowPeer

interface XWindowPeer: com::sun::star::lang::XComponent
{
XToolkit getToolkit();
[oneway] void setPointer( [in] XPointer Pointer );
[oneway] void setBackground( [in] long Color );
[oneway] void invalidate ( [in] short Flags );
[oneway] void invalidateRect( [in] Rectangle Rect, [in]

short Flags );

};

Method getToolkit (Table 70) returns the visual class, which created this object. Method setPointer sets the mouse pointer. Method setBackground sets the background color. Method invalidate invalidates the whole window using an InvalidateStyle. Method invalidateRect invalidates a rectangular area of the window using an InvalidateStyle.

Interface XToolkit (Table 71) specifies a factory interface for the windowing toolkit. This is similar to the abstract window toolkit (AWT) in JAVA. Interface XToolkit inherits from interface XInterface (Table 2).

TABLE 71
INTERFACE XToolkit

```
interface XToolkit: com::sun::star::uno::XInterface
{
com::sun::star::awt::XWindowPeer getDesktopWindow()
com::sun::star::awt::Rectangle getWorkArea();
com::sun::star::awt::XWindowPeer createWindow( [in]
    com::sun::star::awt::WindowDescriptor Descriptor)
  raises (
    com::sun::star::lang::IllegalArgumentException );
sequence<com::sun::star::awt::XWindowPeer>
    createWindows ( [in]
    sequence<com::sun::star::awt::WindowDescriptor>
    Descriptors )
  raises(
    com::sun::star::lang::IllegalArgumentException );
com::sun::star::awt::XDevice
    createScreenCompatibleDevice( [in] long Width,
              [in] long Height );
com::sun::star::awt::XRegion createRegion();
};
```

Method getDesktopWindow (Table 71) returns the desktop window. Method getWorkArea returns the complete work area for this toolkit. Method createWindow creates a new window using the given descriptor. Method createWindow throws exception IllegalArgumentException(Table 42). Method createWindows returns a sequence of windows, which are newly created using the given descriptors. Method createWindows throws exception IllegalArgumentException Method createScreenCompatibleDevice creates a virtual device that is compatible with the screen. Method createRegion creates a region.

Structure WindowDescriptor (Table 72) describes a window. Field Type specifies the type of window. Field WindowServiceName specifies the name of the component service (“ListBox”, “PushButton”). A zero length name means that the vcl creates a blank top, a container, or a simple window. Field Parent specifies the parent of the component. If the Parent==0&&ParentIndex==−1, the window is on the desktop. Field ParentIndex specifies the index of the parent window, if available. If Parent == 0 and this structure is a member of an array, this is the offset from the beginning of the array to the parent. A value of −1 means desktop. Field Bounds specifies the position and size of the window. This member is ignored if the window attribute is WA_FULLSIZE. Field WindowAttributes contains some of the WA_* attributes.

TABLE 72
STRUCTURE WindowDescriptor

struct WindowDescriptor
com::5Un::star::awt::WindowClass Type;
string WindowServiceName;
com::sun::star::awt::XWindowPeer Parent;
short ParentIndex;
com::sun::star::awt::Rectangle Bounds;
long WindowAttributes;
};

Enumeration WindowClass (Table 73) specifies the class of a window. Value TOP specifies a top-level window on the desktop. It is also a container. Value MODALTOP is a modal top-level window on the desktop. It is also a container. Value CONTAINER is a container that may contain other components. It is not a top window. Value SIMPLE is the simplest window. It can be a container.

TABLE 73
ENUMERATION WindowClass

enum WindowClass
{
TOP,
MODALTOP,
CONTAINER,
SIMPLE
};

Interface XDevice (Table 74 and FIG. 10A) provides information about a graphical output device and offers a factory for the graphics, which provides write operations on the device. Interface XDevice inherits from interface XInterface (Table 2).

TABLE 74
INTERFACE XDevice

```
interface XDevice: com::sun::star::uno::XInterface
{
XGraphics createGraphics();
XDevice createDevice( [in] long nWidth, [in] long
    nHeight );
com::sun::star::awt::DeviceInfo getInfo();
sequence<FontDescriptor>getFontDescriptors();
com::sun::star::awt::XFont getFont ( [in] FontDescriptor
    aDescriptor );
XBitmap createBitmap( [in] long nX, [in] long nY,
    [in] long nWidth, [in] long nHeight );
XDisplayBitmap createDisplayBitmap( [in] XBitmap Bitmap
  );
};
```

Method createGraphics (Table 74) creates a new graphics, which output operation direct to this device. Method createDevice creates a new device, which is compatible with this one. If the device does not support the GETBITS device capability, this method returns NULL. Method getInfo returns information about the device. Method getFontDescriptors returns the list of available font descriptors.

Method getFont (Table 74) returns information about a font offered by this device. Parameter aDescriptor specifies the description of a font, and specifies that the unit of measure is pixel for this device.

Method createBitmap (Table 74) creates a bitmap with the current device depth. If the specified area does not lie entirely in the device, the bits outside are not specified. Method createDisplayBitmap creates a device-compatible bitmap. The data of the bitmap is in process memory instead of in the device, so the output operation is fast.

Interface XGraphics (Table 75) provides the basic output operation of a device. Interface XGraphics inherits from interface XInterface (Table 2).

TABLE 75
INTERFACE XGraphics

```
interface XGraphics: com::sun::star::uno::XInterface
{
XDevice getDevice()
SimpleFontMetric getFontMetric ();
[oneway] void setFont ( [in] XFont xNewFont );
[oneway] void selectFont( [in] FontDescriptor
  aDescription );
[oneway] void setTextColor( [in] long nColor );
[oneway] void setTextFillColor( [in] long nColor );
[oneway] void setLineColor( [in] long nColor );
[oneway] void setFillColor( [in] long nColor );
[oneway] void setRasterOp( [in] RasterOperation ROP );
[oneway] void setClipRegion( [in] XRegion Clipping );
[oneway] void intersectClipRegion( [in] XRegion
  xClipping );
[oneway] void push();
[oneway] void pop();
[oneway] void copy( [in] XDevice xSource, [in] long
  nSourceX, [in] long nSourceY, [in] long
  nSourceWidth, [in] long nSourceHeight, [in] long
  nDestX, [in] long nDestY, [in] long nDestWidth,
  [in] long nDestHeight );
[oneway] void draw( [in] XDisplayBitmap xBitmapHandle,
  [in] long SourceX, [in] long SourceY, [in] long
  SourceWidth, [in] long SourceHeight, [in] long
  DestX, [in] long DestY, [in] long DestWidth, [in]
  long DestHeight );
[oneway] void drawPixel( [in] long X, [in] long Y );
[oneway] void drawLine( [in] long X1, [in] long Y1,
  [in] long X2, [in] long Y2 );
[oneway] void drawRect( [in] long X, [in] long Y, [in]
  long Width, [in] long Height );
[oneway] void drawRoundedRect( [in] long X, [in] long
  Y, [in] long Width, [in] long Height, [in] long
  nHorzRound, [in] long nVertRound );
[oneway] void drawpolyLine( [in] sequence<long>DataX,
  [in] sequence<long>DataY );
[oneway] void drawPolygon( [in] sequence<long>DataX,
  [in] sequence<long>DataY );
[oneway] void drawpolyPolygon( [in] sequence<
  sequence<long> >DataX, [in] sequence<
  sequence<long> >DataY);
[oneway] void drawEllipse( [in] long X, [in] long Y,
  [in] long Width, [in] long Height );
[oneway] void drawArc( [in] long X, [in] long Y, [in]
  long Width, [in] long Height, [in] long X1, [in]
  long Y1, [in] long X2, [in] long Y2 );
[oneway] void drawPie( [in] long X, [in] long Y, [in]
  long Width, [in] long Height, [in] long X1,
  [in] long Y1, [in] long X2, [in] long Y2 );
[oneway] void drawChord( [in] long nX, [in] long nY,
  [in] long nWidth, [in] long nHeight, [in] long
  nX1, [in] long nY1, [in] long nX2, [in] long nY2
  );
[oneway] void drawGradient( [in] long nX, [in] long nY,
  [in] long nWidth, [in] long Height, [in] Gradient
  aGradient );
[oneway] void drawText( [in] long X, [in] long Y,
  [in] string Text );
[oneway] void drawTextArray( [in] long X, [in] long Y,
  [in] string Text1 [in] sequence<long>Longs );
};
```

Method getDevice (Table 75) returns the device of this graphics. Method getFontMetric returns the font metric of the current font. Method setFont sets the font used by text operations. Method selectFont creates a new font and sets the font. Method setTextColor sets the text color used by text operations. Method setTextFillColor sets the fill color used by text operations. Method setLineColor sets the line color. Method setFillColor sets the fill color. Method setRasterOp sets the raster operation. If the device does not support raster operations, this call is ignored. Method setClipRegion sets the clip region to specified clipping. Method intersectClipRegion builds the intersection with the current region. Method push saves all current settings (Font, TextColor, TextFillColor, LineColor, FillColor, RasterOp, ClipRegion). Method pop restores all previous saved settings. Method copy copies a rectangle of pixels from another device into this one. Method draw draws a part of the specified bitmap to the output device. Method drawpixel sets a single pixel in the output device. Method drawLine draws a line in the output device. Method DrawRect draws a rectangle in the output device. Method drawRoundedRect draws a rectangle with rounded corners in the output device. Method drawPolyLine draws multiple lines in the output device at once. Method DrawPolygon draws a polygon line in the output device. Method drawPolyPolygon draws multiple polygons in the output device at once. Method drawEllipse draws an ellipse in the output device. Method drawArc draws an arc (part of a circle) in the output device. Method drawPie draws a circular area in the output device. Method drawChord draws a chord of a circular area in the output device. A chord is a segment of a circle. You get two chords from a circle if you intersect the circle with a straight line joining two points on the circle. Method drawGradient draws a color dispersion in the output device. Method drawText draws text in the output device. Method drawTextArray draws texts in the output device using an explicit kerning table.

Structure SimpleFontMetric (Table 76) describes the general metrics of a font. Field Ascent specifies the portion of a lower case character that rises above the height of the character “x” of the font. For example, the letters ‘b’, ‘d’, ‘h’, ‘k’ and ‘l’ have an ascent unequal to 0. Ascent is measured in pixels, thus the font metric is device dependent. Field Descent specifies the portion of a letter falling below the baseline. For example, the letters ‘g’, ‘p’, and ‘y’ have a descent unequal to 0. Descent is measured in pixels, thus the font metric is device dependent. Field Leading specifies the vertical space between lines of this font, and is also called internal line spacing. The leading is measured in pixels, thus the font metric is device dependent. Field Slant specifies the slant of the characters (italic). The slant is measured in degrees from 0 to 359. Field FirstChar specifies the code of the first printable character in the font. Field LastChar specifies the code of the last printable character in the font.

TABLE 76
STRUCTURE SimpleFontMetric

struct SimpleFontMetric
{
short Ascent;
short Descent;
short Leading;
char FirstChar;
char LastChar;
};

Interface XFont (Table 77) describes a font on a specific device. All values are in pixels within this device. Interface XFont inherits from interface XInterface (Table 2).

TABLE 77
INTERFACE XFont

```
interface XFont: com::sun::star::uno::XInterface
{
com::sun::star::awt::FontDescriptor
  getFontDescriptor ()
com::sun::star::awt::SimpleFontMetric getFontMetric();
short getCharWidth( [in] char c );
sequence<short>getCharWidths( [in] char nFirst, [in]
  char nLast );
long getStringWidth( [in] string str );
long getStringWidthArray( [in] string str, [out]
  sequence<long>aDXArray );
void getKernPairs( [out] sequence<char>Chars1, [out]
  sequence<char>Chars2, [out] sequence<short>Kerns
  );
};
```

Method getFontDescriptors (Table 77) returns the description of the font. Method getFontMetric returns additional information about the font. Method getCharWidth returns the width of the specified character measured in pixels for the device. Method getCharWidths returns a sequence of the widths of subsequent characters for this font. Method getStringWidth returns the width of the specified string of characters measured in pixels for the device. Method getStringWidthArray returns the width of the specified string of characters measured in pixels for the device. In this method, parameter aDXArray receives the width of every single character measured in pixels for the device. Method getKernPairs queries the kerning pair table.

Structure FontDescriptor (Table 78) describes the characteristics of a font. For example, this structure can be used to select a font. Field Name specifies the exact name of the font (“Arial”, “Courier”, “Frutiger”). Field Height specifies the height of the font in the measure of the destination. Field Width specifies the width of the font in the measure of the destination. Field StyleName specifies the style name of the font (“Bold”, “Fett”, “Italic Bold”). Field Family specifies the general style of the font. Use one value out of the constant group FontFamily. Field CharSet specifies the character set, which is supported by the font. Use one value out of the constant group CharSet. Field Pitch specifies the pitch of the font. Use one value out of the constant group FontPitch. Field CharacterWidth specifies the character width. Depending on the specified width, a font that supports this width may be selected. The value is expressed as a percentage. Field Weight specifies the thickness of the line. Depending on the specified weight, a font that supports this thickness may be selected. The value is expressed as a percentage. Field Slant specifies if there is a character slant (italic). Field Underline uses one value out of the constant group FontUnderline. Field Strikeout uses one value out of the constant group FontStrikeout. Field Orientation specifies the rotation of the font. The unit of measure is degrees; 0 is the baseline. Field Kerning, for requesting, it specifies if there is a kerning table available: for selecting, it specifies if the kerning table is to be used. Field WordLineMode specifies if only words get underlined. A value of TRUE means that only non-space characters get underlined while a value of FALSE means that the spacing also gets underlined. This property is only valid if the property FontDescriptor:: Underline is not FontUnderline:: NONE. Field Type specifies the technology of the font representation. One or more values out of the constant group FontType can be combined by an arithmetical or-operation.

TABLE 78
STRUCTURE FontDescriptor

struct FontDescriptor
{
string Name;
short Height;
short Width;
string StyleName;
short Family;
short CharSet;
short Pitch;
float CharacterWidth;
float Weight;
com::sun::star::awt::FontSlant Slant;
short Underline;
short Strikeout;
float Orientation;
boolean Kerning;
boolean WordLineMode;
short Type;
};

Enumeration FontSlant (Table 79) is used to specify the slant of a font. Value NONE specifies a font without slant. Value OBLIQUE specifies an oblique font (slant not designed into the font). Value ITALIC specifies an italic font (slant designed into the font). Value DONTKNOW specifies a font with an unknown slant. Value REVERSE_OBLIQUE specifies a reverse oblique font (slant not designed into the font). Value REVERSE_ITALIC specifies a reverse italic font (slant designed into the font).

TABLE 79
ENUMERATION FontSlant

enum FontSlant
{
NONE,
OBLIQUE,
ITALIC,
DONTKNOW,
REVERSE_OBLIQUE,
REVERSE_ITALIC
};

The values in enumeration RasterOperation (Table 80) are used to specify the binary pixel-operation applied when pixels are written to the device. Value OVERPAINT sets all pixels as written in the output operation. Value XOR uses the pixel written as one and the current pixel as the other operator of an exclusive or-operation. Value ZEROBITS causes all bits, which are affected by this operation, to be set to 0. Value ALLBITS causes all bits, which are affected by this operation, to be set to 1. Value INVERT causes all bits, which are affected by this operation, to be inverted.

TABLE 80
ENUMERATION RasterOperation

enum RasterOperation
{
OVERPAINT,
XOR,
ZEROBITS,
ALLBITS,
INVERT
};

Interface XRegion (Table 81 and FIGS. 10A and 10B) manages multiple rectangles, which make up a region. Interface XRegion inherits from interface XInterface (Table 2).

TABLE 81
INTERFACE XRegion

interface XRegion: com::sun::star::uno::XInterface
{
Rectangle getBounds();
[oneway] void clear();
[oneway] void move( [in] long nHorzMove, [in] long

nVertMove );

[oneway] void unionRectangle( [in] Rectangle Rect );
[oneway] void intersectRectangle( [in] Rectangle Region );
[oneway] void excludeRectangle( [in] Rectangle Rect );
[oneway] void xOrRectangle( [in] Rectangle Rect );
[oneway] void unionRegion( [in] XRegion Region );
[oneway] void intersectRegion( [in] XRegion Region );
[oneway] void excludeRegion( [in] XRegion Region );
[oneway] void xOrRegion( [in] XRegion Region );
sequence<Rectangle> getRectangles();
};

Method getBounds (Table 81) returns the bounding box of the shape. Method clear makes this region an empty region. Method move moves this region by the specified horizontal and vertical delta. Method unionRectangle adds the specified rectangle to this region. Method intersectRectangle intersects the specified rectangle with the current region. Method excludeRectangle removes the area of the specified rectangle from this region. Method xOrRectangle applies an exclusive-or operation with the specified rectangle to this region. Method unionRegion adds the specified region to this region. Method intersectRegion intersects the specified region with the current region. Method excludeRegion removes the area of the specified region from this region. Method xOrRegion applies an exclusive-or operation with the specified region to this region. Method getRectangles returns all rectangles, which are making up this region.

Interface XDisplayBitmap (Table 82) specifies an object as a bitmap for which data is formatted for a specific output device. Drawing of this bitmap is only valid on a compatible device. Interface XDisplayBitmap inherits from interface XInterface (Table 2).

TABLE 82
INTERFACE XDisplayBitmap

interface XDisplayBitmap:

com::sun::star::uno::XInterface

{
};

Structure Gradient (Table 83) describes a color dispersion within an area. Field Style specifies the style of the gradient. Field StartColor specifies the color at the start point of the gradient. Field EndColor specifies the color at the end point of the gradient. Field Angle specifies the angle of the gradient in 1/10 degree. Field Border specifies the percent of the total width where just the start color is used. Field XOffset specifies the X-coordinate, where gradient begins. Field Yoffset specifies the Y-coordinate, where gradient begins. Field StartIntensity specifies the intensity at the start point of the gradient. Field EndIntensity specifies the intensity at the end point of the gradient. Field StepCount specifies the number of steps of change color.

TABLE 83
STRUCTURE Gradient

struct Gradient
{
com::sun::star::awt::GradientStyle Style;
long StartColor;
long EndColor;
short Angle;
short Border;
short XOffset;
short YOffset;
short StartIntensity;
short EndIntensity;
short StepCount;
};

Enumeration GradientStyle (Table 84) specifies the style of color dispersion. Value LINEAR specifies a linear gradient. Value AXIAL specifies an axial gradient. Value RADIAL specifies a radial gradient. Value ELLIPTICAL specifies an elliptical gradient. Value SQUARE specifies a gradient in the shape of a square. Value RECT specifies a gradient in the shape of a rectangle.

TABLE 84
ENUMERATION GradientStyle

enum GradientStyle
{
LINEAR,
AXIAL,
RADIAL,
ELLIPTICAL,
SQUARE,
RECT
};

Structure Devicelnfo (Table 85) contains information about a device. Field Width contains the width of the device in pixels. Field Height contains the height of the device in pixels. Field LeftInset contains the inset from the left. Field TopInset contains the inset from the top. Field RightInset contains the inset from the right. Field BottomInset contains the inset from the bottom. Field PixelPerMeterX contains the X-axis resolution of the device in pixel/meter. Field PixelPerMeterY contains the Y-axis resolution of the device in pixel/meter. Field BitsPerPixel contains the color-depth of the device. Field Capabilities specifies special operations, which are possible on the device.

TABLE 85
STRUCTURE DeviceInfo

struct DeviceInfo
{
long Width;
long Height;
long LeftInset;
long TopInset;
long RightInset;
long BottomInset;
double PixelPerMeterX;
double PixelPerMeterY;
short BitsPerPixel;
long Capabilities;
};

Interface XBitmap (Table 86) provides a bitmap in the Microsoft DIB format. Interface XBitmap inherits from interface XInterface (Table 2). Method getSize returns the size of the bitmap in pixels. Method getDIB returns the device independent bitmap. Method getMaskDIB returns the transparence mask of the device independent bitmap.

TABLE 86
INTERFACE XBitmap

interface XBitmap: com::sun::star::uno::XInterface
{
com::sun::star::awt::Size getSize();
sequence<byte> getDIB();
sequence<byte> getMaskDIB();
};

Structure Size (Table 87) specifies the two-dimensional size of an area using width and height. Field Width specifies the width. Field Height specifies the height.

TABLE 87
STRUCTURE Size

struct Size
{
long Width;
long Height;
};

Interface XPointer (Table 88) gives access to the type of mouse pointer. Interface XPointer inherits from interface XInterface (Table 2). Method setType selects a SystemPointer for this mouse pointer. Method getType returns the currently set SystemPointer of this mouse pointer.

TABLE 88
INTERFACE XPointer

interface XPointer: com::sun::star::uno::XInterface
{
[oneway] void setType( [in] long nType );
long getType();
};

Table 89 is one embodiment of a remote virtual device interface XRmVirtualDevice that is included in one embodiment of lightweight component 230.

TABLE 89
INTERFACE XRmVirtualDevice

interface XRmVirtualDevice :

com::sun::star::uno::XInterface

{
[oneway] void Create( [in] unsigned long nCompDev,

[in] long nWidth, [in] long nHeight, [in] unsigned
short nBitCount );

[oneway] void SetOutputSizePixel( [in] long nWidth,

[in] long nHeight );

[oneway] void ResizeOutputSizePixel( [in] long nWidth,

[in] long nHeight );

};

Table 90 is one embodiment of interfaces XRmBitmap and XRmJavaBitmap that are included in one embodiment of lightweight component 230. These interfaces are used when a runtime environment component on server computer system needs to display a bitmap on user device 102i.

TABLE 90
INTERFACES XRmBitmap and XRmJavaBitmap

interface XRmBitmap : com::sun::star::uno::XInterface
{
/**
InitiateTransfer: initialize bitmap to empty with

width, height and depth the next parameters
determine the format of the scanlines transported
by subsequent Transfer calls: palette for palette
bitmaps, the palette entries are in the order
blue(or index), green, red, bool. the bool tells
whether the first byte is an index or not.
(implementation detail: this is a vcl BitmapColor)
format and scanlinesize determine how to interpret
the scanlines transported in each Transfer call.
compressiontype marks the compression algorithm
used on the byte sequences in Transfer call with 0
meaning uncompressed. InitiateTransfer with width
and height set to 0 is legal, the bitmap data
should be purged then.

*/
[oneway] void InitiateTransfer( [in] long width,

[in] long height, [in] long depth, [in] sequence<
byte > palette, [in] long format, [in] long
scanlinesize, [in] long compressiontype );

/**
* Transfer: transports one or more scanlines of the

bitmap initialized in InitiateTransfer.

*/
[oneway] void Transfer( [in] ByteSequence aData );
unsigned long QueryBitmapPtr();
[oneway] void Draw( [in] long nDestX, [in] long

nDestY, [in] long nDestWidth, [in] long
nDestHeight, [in] long nSrcX, [in] long nSrcY,
[in] long nSrcWidth, [in] long nSrcHeight, [in]
XRmOutputDevice xOutputDevice );

[oneway] void DrawEx( [in] long nDestX, [in] long

nDestY, [in] long nDestWidth, [in] long
nDestHeight, [in] long nSrcX, [in] long nSrcY,
[in] long nSrcWidth, [in] long nSrcHeight, [in]
XRmBitmap xBitmap, [in] XRmBitmap xBitmapMask,
[in] XRmOutputDevice xOutputDevice, [in] boolean
bAlpha );

[oneway] void DrawMask( [in] long nDestX, [in] long

nDestY, [in] long nDestWidth, [in] long
nDestHeight, [in] long nSrcX, [in] long nSrcY,
[in] long nSrcWidth, [in] long nSrcHeight, [in]
XRmBitmap xBitmap, [in] unsigned long nColor, [in]
XRmOutputDevice xOutputDevice );

[oneway] void CreateBitmap( [in] long nX, [in] long

nY, [in] long nWidth, [in] long nHeight, [in]
XRmOutputDevice xOutputDevice );

void GetBitmap( [out] ByteSequence rData );
};
interface XRmJavaBitmap : XRmBitmap
{
[oneway] void SetImageData( [in] long nBitCount, [in]

long nWidth, [in] long nHeight, [in] ByteSequence
aColorMap, [in] ByteSequence aIndexData, [in]
LongSequence aRGBData);

void GetImageData( [out] long rBitCount, [out] long

rWidth, [out] long rHeight, [out] ByteSequence
rColorMap, [out] ByteSequence rBitmapData, [out]
LongSequence rRGBData, [out] long rAlphaMask,
[out] long rRedMask, [out] long rGreenMask, [out]
long rBlueMask);

};

Table 91 is one embodiment of interfaces XRmPrintObserver, XRmPrinterEnvironment, XRmPrinter, and XRmPrintSpooler that are included in one embodiment of lightweight component 230. These interfaces are used when a runtime environment component on server computer system needs to print to a printer coupled to user device 102i.

TABLE 91
INTERFACES XRmPrintObserver,
ZRmPrinterEnvironment, XRmPrinter, and XRmPrintSpooler

{
// [in] Eingabe-Parameter. Der “Server” auf dem das

Object liegt ist der Remote-Client.

// Also “Server” eigentlich “Display”
// [oneway] => Kein warten auf Antwort
typedef sequence< byte, 1 > RmJobSetup;
typedef sequence< byte, 1 > RmQueueInfo;
typedef sequence< byte, 1 > RmPrinterPage;
typedef sequence< string, 1 > StringSequence;
interface XRmPrinterObserver :

com::sun::star::uno::ZInterface

{
[oneway] void PrinterSettingsChanged();
};
interface XRmPrinterEnvironment :

com::sun::star::uno::XInterface

{
unsigned short GetQueueCount();
void GetQueueInfo( [in] unsigned short nQueue, [out]

RmQueueInfo rRmQueueInfo );

boolean GetPrinterInfor( [in] string sPrinterName,

[out] RmQueueInfo rRmQueueInfo );

void GetPrinterNames( [out] StringSequence

rPrinterNames );

stringGetDefaultPrinterName ();
void SetObserver( [in] XRmPrinterObserver rObserver );
};
interface XRmPrinter : com::sun::star::uno::XInterface
{
void Create( [in] RmQueueInfo aRmQueueInfo, [out]

RmJobSetup rRmJobSetup );

boolean SetJobSetup( [inout] RmJobSetup rRmJobSetup );
boolean SetOrientation( [in] unsigned short

nOrientation, [inout] RmJobSetup rRmJobSetup );

boolean SetPaperBin( [in] unsigned short nPaperBin,

[inout] RmJobSetup rRmJobSetup );

boolean SetPaper( [in] unsigned short nPaper, [inout]

RmJobSetup rRmJobSetup );

boolean SetPaperSizeUser( [in] long nWidth, [in] long

nHeight, [inout] RmJobSetup rRmJobSetup );

void GetPageInfo( [out] long rOutWidth, [out] long

rOutHeight, [out] long rPageOffX, [out] long
rPageOffY, [out] long rPageWidth, [out] long
rPageHeight );

unsigned short GetPaperBinCount();
string GetPaperBinName( [in] unsigned short

nPaperBin );

/** query the printer for its capabilities (mainly to

decide whether it is possible to bring up a
printer setup dialogue)

*/
unsigned long GetCapabilities( [in] unsigned short

nType );

/** brings up a UI to setup the current jobsetup.

Returns the modified (and still current ) jobsetup
if successful. If not successful (e.g. user
cancel) the return is empty. Mote: return is
delivered as a UserEvent on the EventListener of
xParent

*/
[oneway] void UserSetup( [in] XRmFrameWindow xParent,

[in] unsigned long EventID );

};
interface XRmSpoolLauncher :

com::sun::star::uno::XInterface

{
boolean LaunchSpooler( [in] string sUserName, [in]

string sPassword );

};
interface XRmPrintSpooler :

com::sun::star::uno::XInterface

{
void Create( [in] RmJobSetup jobSetup );
boolean StartJob( [in] unsigned short nCopies, [in]

boolean bCollate, [in] string aJobName, [in]
string sFileName , [in] boolean bPrintFile);

[oneway] void SpoolPage( [in] RmPrinterPage page );
void AbortJob();
void EndJob();
};
};

Table 92 is one embodiment of interface XRmFileStream. Table 93 is one embodiment of interface XRmFSys. Both of these interfaces are included in one embodiment of lightweight component 230. These interfaces are used when a runtime environment component reads or writes data on a storage medium of user device 102i, or needs to obtain information about data stored on a storage medium of user device 102i. In this embodiment, object BeanService 532 receives, as described above, a handle to object ClientFactory 515. The handle to object ClientFactory 515 to instantiate an object on the user device to access a particular capability on the user device, e.g., the file system, printing, sound, etc.

TABLE 92
INTERFACE XRmFileStream

{
typedef sequence< byte, 1 > RFSByteSequence;
interface XRmFileStreaqm :

com::sun::star::uno::XInterface

{ // interface
// param a Filename: file to open
// param nOpenMode: file mode read
// param bIsOpen: file opend successfully
// param bIsWritable: file opend writable
// param nStreamMode: stream mode
// param nError: Error Code
// returns fileHandle: handle
unsigned long open( [in] string aFilename,

[in]unsigned short nOpenMode, [out] boolean
bIsOpen, [out] boolean bIsWritable, [out]
unsigned short nStreamMode, [out]unsigned long
nError);

// param handle: filehandle
void close();
// param aData: data read from stream
// param nSize: number of bytes to read
// param nError: errorcode
// returns: number of bytes that were successfully read
unsigned long getData([out] RFSByteSequence aData,

[in] unsigned long nSize, [out] unsigned long
nError);

// param nData: data to write to stream
// param nSize: number of bytes to write
// param nError: errorcode
// returns: number of bytes that were successfully
// written
unsigned long putData([in] RFSByteSequence aData, [in]

unsigned long nSize, [out] unsigned long nError);

// param nPos: desired position
// param nError: errorcode
// returns: new position
unsigned long seekPos([in] unsigned long nPos, [out]

unsigned long Error);

// param nSize: new filensize
// param nError: errorcode
Void setSize([in] unsigned long nSize, [out] unsigned

long nError);

// param nByteOffset: where to start locking
// param nBytes: how many bytes to lock
// param nError: errorcode
// returns: success
boolean lockRange([in] unsigned long nByteOffset, [in]

unsigned long nBytes, [out] unsigned long nError);

// param nByteOffset: where to start unlocking
// param nBytes: how many bytes to unlock
// param nError: errorcode
// returns: success
boolean unlockRange([in] unsigned long nByteOffset,

[in] unsigned long nBytes, [out] unsigned
longnError);

};};

TABLE 93
INTERFACE XRmFSys

{
struct FileStatMembers
{

| | |
|---|---|
| unsigned long | nError; |
| unsigned long | nKinfFlags; |
| unsigned long | nSize; |
| string | aCreator; |
| string | aType; |
| unsigned long | aDateCreated; |
| unsigned long | aTimeCreated; |
| unsigned long | aDateModified; |
| unsigned long | aTimeModified; |
| unsigned long | aDateAccessed; |
| unsigned long | aTimeAccessed; |

};
typedef sequence< strin, 1 > DirEntrySequence;
typedef sequence< FileStatMembers, 1 >

FileStatSequence;

typedef sequence< unsigned long, 1 > FSysSortSequence;
interface XRmFSys : com::sun::star::uno::XInterface
{ // interface
boolean isCaseSensitive ( [in] string aDirEntry);
string tempName ([in] string aDirEntry, [in] unsigned

long eKind);

boolean toAbs ( [in] string aDirEntry, [out] string

aResult);

boolean toRel ( [in] string aDirEntry, [out] string

aResult);

boolean toRelRel ( [in] string aDirEntry, [in] string

aRelative, [out] string aResult);

boolean makeShortName ( [inout] string aDirEntry, [in]

string aLongName, [in] unsigned long nCreateKind,
[in] boolean bUseTilde, [in] unsigned long
nStyle);

unsigned short scan ( [in] string aDirEntry, [out]

DirEntrySequence aDirEntryList, [out]
FileStatusSequence aFileStatList, [in]
FSysSortSequence aSortLst, [in] string aNameMask,
[in] unsigned short nAttMask, [in] boolean
bFillFileStatList);

boolean update ( [out] FileStatMembers aFileStat, [in]

string aDirEntry, [in] boolean
bAccessRemovableDevice);

unsigned long queryDiskSpace ( [in] string aPath, [out]

unsigned long nFreeBytes, [out] unsigned long
nTotalBytes);

string getDevice ( [in] string aDirEntry);
string getVolume ( [in] string aDirEntry);
unsigned long getPathStyle ( [in] string aDevice);
boolean hasReadOnlyFlag();
boolean getReadOnlyFlag ( [in] string aDirEntry);
boolean exists ( [in] string aDir, [in] unsigned long

nAccess);

boolean first ( [inout] string aDir);
boolean find ( [in] string aDirEntry, [in] string

aPfad, [in] char cDelim, [out] string aResult);

boolean setCWD ( [in] string aDir, [in] boolean

bSloppy);

boolean makeDir ( [in] string aDir, [in] boolean

bSloppy);

long setReadOnlyFlag ( [in] string aDirEntry, [in]

boolean bRO);

void setDateTime ( [in] string aFileName, [in] unsigned

long nDate, [in] unsigned long nTime);

unsigned long moveTo ( [in] string aFromDir, [in]

string aToDir);

unsigned long kill ( [in] string aFromDir, [in]unsigned

long nActions);

};

};

Table 94 is one embodiment of interfaces XSoundCallBack and XRMSound that are included in one embodiment of lightweight component 230. These interfaces are used when a runtime environment component needs to play sounds on user device 102i.

TABLE 94
INTERFACES XSoundCallBack and XRMSound

{
// ----------------- - SoundSequence - ----------------
typedef sequence< byte, 1 > SoundSequence;
// ------------------ - SoundCallback - ----------------
-
interface XSoundCallback :

com::sun::star::uno::XInterface

{
[oneway] void Notify( [in] unsigned short

nNotification, [in] unsigned long nError );

};
// ------------ - XRmSound - ------------
interface XRmSound : com::sun::star::uno::XInterface
{
[oneway] void Create( [in] XSoundCallback

xSoundCallback );

unsigned long Transfer( [in] unsigned long nExtraData,

[in] SoundSequence aData, [in] string aFileName );

[oneway] void SetStartTime( [in] unsigned long

nStartTime );

[oneway] void SetPlayTime( [in] unsigned long nPlayTime

);

[oneway] void SetLoopMode( [in] boolean bLoop );
[oneway] void ClearError();
[oneway] void Play();
[oneway] void Stop();
[oneway] void Pause();
};
};

Table 95 is one embodiment of interface XRmStatus that is included in one embodiment of lightweight component 230. This interfaces is used when a runtime environment component needs the status of user device 102i.

TABLE 95
INTERFACES XRmStatus

interface XRmStatus : com::sun::star::uno::XInterface
{
unsigned long GetRemoteVersion();
unsigned long GetSystemType();
unsigned long GetSystemCharSet();
void ShowError( [in] string aMsg, [in] unsigned short

nCode );

void ShowWarning( [in] string aMsg, [in] unsigned short

nCode );

void ShowInfo( [in] string aMsg, [in] unsigned short

nCode );

void Quit();
};
};

Those skilled in the art will readily understand that the operations and actions described herein represent actions performed by a CPU of a computer in accordance with computer instructions provided by a computer program. Therefore, lightweight component 230 may be implemented by a computer program causing the CPU of the computer to carry out instructions representing the individual operations or actions as described hereinbefore. The computer instructions can also be stored on a computer-readable medium, or they can be embodied in any computer-readable medium such as any communications link, like a transmission link to a LAN, a link to the internet, or the like.

Thus, lightweight component 230 can be implemented by a computer program comprising computer program code or application code. This application code or computer program code may be embodied in any form of a computer program product. A computer program product comprises a medium configured to store or transport this computer-readable code, or in which this computer-readable code may be embedded. Some examples of computer program products are CD-ROM discs, ROM cards, floppy discs, magnetic tapes, computer hard drives, servers on a network, and carrier waves. The computer program product may also comprise signals, which do not use carrier waves, such as digital signals transmitted over a network (including the Internet) without the use of a carrier wave.

The storage medium including the applications/services executed on a server may belong to server computer system 100 itself. However, the storage medium also may be removed from server computer system 100. The only requirement is that the applications/services are accessible by server computer system 100 so that the application/service corresponding to lightweight component 230 can be executed by server 100.

Herein, a computer memory refers to a volatile memory, a non-volatile memory, or a combination of the two in any one of these devices. Similarly, a computer input unit and a display unit refer to the features providing the required functionality to input the information described herein, and to display the information described herein, respectively, in any one of the aforementioned or equivalent devices.

While the present invention has been explained in connection with certain embodiments thereof, other embodiments will be apparent to those skilled in the art from consideration of the specification and practice of the embodiment of the present invention disclosed therein. It is intended that the specification and examples be considered as exemplary only, without limiting the spirit and scope of the invention.

We claim:

1. A method for presenting a runtime environment component service by a first computer system to a second computer system over a communication network, said method being performed by said first computer system and comprising:
generating a user interface infrastructure, on said first computer system, to receive graphic user interface events from said second computer system and to send remote graphic user interface commands to said second computer system; and
using said user interface infrastructure to initialize said runtime environment component service wherein said runtime environment component service sends graphic user interface commands to said user interface infrastructure.

2. The method of claim 1 further comprising:
receiving by said user interface infrastructure a remote input action event via said communication network, said remote input action event being generated in said second computer system by a lightweight component corresponding to said runtime environment component service.

3. The method of claim 2 further comprising:
transmitting an input event to said runtime environment component service by said user interface infrastructure in response to said remote input action event.

4. The method of claim 3 further comprising:
processing said input event by said runtime environment component service.

5. The method of claim 4 further comprising:
generating a graphic user interface command to said user interface infrastructure by said runtime environment component service.

6. The method of claim 5 further comprising:
transmitting a remote graphic user interface command to said lightweight component by said graphic user interface infrastructure in response to said graphic user interface command.

7. A method for presenting a runtime environment component service by a first computer system to a second computer system over a communication network, said method being performed by said first computer system and comprising:
receiving a remote input action command for a runtime environment component service via said communication network, said remote input action command being generated in said second computer system by a lightweight component corresponding to said runtime environment component service;
transmitting a local input action command to said runtime environment component service in response to said remote input action command;
processing said local input action command by said runtime environment component service;
generating a local output command by said runtime environment component service for a graphical user interface; and
transmitting a remote output command to said lightweight component in response to said local output command.

8. The method of claim 7 wherein said runtime environment component service is in an office application suite.

9. The method of claim 7 wherein said method further comprises:
receiving said local output command by a local window object and in response generating said remote output command by said local window object.

10. The method of claim 7 wherein said method further comprises:
receiving said remote input action command by a local window object and in response generating said local input action command by said local window object.

11. The method of claim 9 wherein said method further comprises:
receiving said remote input action command by said local window object, and in response generating said local input action command by said local window object.

12. The method of claim 10 wherein said remote input action command is a user interface event.

13. The method of claim 11 wherein said remote input action command is a user interface event.

14. A method comprising:
receiving a command by a service executing on a computer system to create an infrastructure for executing a runtime environment component service, wherein said command is from a component executing on a user device; and
issuing an instruction to create an instance of a remote frame window on said user device.

15. The method of claim 14 further comprising:
generating an instance of a local window on said computer system by said service, wherein said local window issues remote instructions to said remote window frame in response to instructions from said runtime environment component service.

16. The method of claim 15 further comprising:
querying said remote frame window by said local window to determine properties of said remote frame window.

17. The method of claim 15 further comprising:
generating, on said computer system, a local frame for said local window.

18. The method of claim 17 further comprising:
receiving, by said local frame, a command from said user device to load a document.

19. The method of claim 18 further comprising:
issuing, in response to said command to load a document, a command by said local frame to said runtime environment component service to create an instance of a runtime environment component service window on said computer system.

20. The method claim 19 further comprising;
issuing a command by said local frame to said runtime environment component service to load said document in said runtime environment component service window.

21. The method of claim 20 further comprising:
issuing a command from said runtime environment component service to said local window to display said document.

22. A method for enabling a user device to run a runtime environment component on another computer, said method comprising:
running a browser on said user device; and
running a lightweight component within said browser, wherein said lightweight component receives user input actions on said user device and generates corresponding user interface events to said another computer for processing by said runtime environment component.

23. The method of claim 22 further comprising:
downloading lightweight component into said user device.

24. A computer program product comprising computer code comprising:
a remote frame window class comprising:
a remote output device interface; and
a remote frame window interface.

25. The computer program product of claim 24 wherein said computer code further comprises:
a bean frame class comprising a frame interface.

26. The computer program product of claim 24 wherein said computer code further comprises:
a bean window class comprising:
an event handler interface; and
an window peer interface.

27. The computer program product of claim 24 wherein said computer code further comprises:
an abstract windowing toolkit.

28. A computer program product comprising computer code for a method for presenting a runtime environment component service by a first computer system to a second computer system over a communication network, said method being performed by said first computer system, said method comprising:
generating a user interface infrastructure, on said first computer system, to receive graphic user interface events from said second computer system and to send remote graphic user interface commands to said second computer system; and
using said user interface infrastructure to initialize said runtime environment component service wherein said runtime environment component service sends graphic user interface commands to said user interface infrastructure.

29. A computer program product comprising computer code for a method for presenting a runtime environment component service by a first computer system to a second computer system over a communication network, said method being performed by said first computer system and comprising:
receiving a remote input action command for a runtime environment component service via said communication network, said remote input action command being generated in said second computer system by a lightweight component corresponding to said runtime environment component service;
transmitting a local input action command to said runtime environment component service in response to said remote input action command;
processing said local input action command by said runtime environment component service;
generating a local output command by said runtime environment component service for a graphical user interface; and
transmitting a remote output command to said lightweight component in response to said local output instruction.
